(19) United States
(12) Patent Application Publication
(10) Pub. No.: US 2007/0073514 A1
(43) Pub. Date: Mar. 29, 2007

(54) Walking analyzer

(75) Inventors: Wataru Nogimori, Kitanagoya-shi (JP); Hideaki Yamaguchi, Toyota-shi (JP); Mitsutoshi Uematsu, Osaka-shi (JP); Akira Kanai, Toyokawa-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA

(21) Appl. No.: 11/526,769

(22) Filed: Sep. 26, 2006

(30) Foreign Application Priority Data
Sep. 26, 2005 (JP) 2005-278729
Oct. 7, 2005 (JP) 2005-295700

(51) Int. Cl. G01C 22/00; G01B 11/02; G01B 11/14

(52) U.S. Cl. 702/160

(57) ABSTRACT

A walking analyzer includes an acceleration sensor detecting an up-down acceleration, a front-rear acceleration, and a right-left acceleration of a person, an acceleration change calculating device for calculating changes of each acceleration in time, a time period extracting device extracting a certain time period in which a certain walking movement is performed on the basis of the changes of the acceleration in time of one of the up-down acceleration, the front-rear acceleration and the right-left acceleration, an estimated indicator calculating device calculating an estimated indicator related to a walking ability and a walking ability estimating device estimating a walking ability by use of the estimated indicator and by use of a predetermined relation between an estimated indicator and a walking ability.

### CROSS REFERENCE TO RELATED APPLICATIONS

This application is based on and claims priority under 35 U.S.C. § 119 to Japanese Patent Applications 2005-278729, filed on Sep. 26, 2005 and 2005-295700, filed on Oct. 7, 2005, the entire contents of which are incorporated herein by reference.

### FIELD OF THE INVENTION

The present invention relates to a walking analyzer for analyzing a walking ability of a person.

### BACKGROUND

According to a known device disclosed in, for example, JP10165395A, the walking analyzer detects an acceleration at the waist portion of the person by means of an acceleration sensor, and on the basis of the detected acceleration, the acceleration sensor outputs a signal. A peak value in the acceleration is detected by calculating a derivative value of the signal, and the peak value is compared to a predetermined threshold. If the peak value is larger than the threshold, it is determined that the person's walking is abnormal (stumbling).

According to the known walking analyzer disclosed in JP2000006608A, an acceleration sensor is attached to the waist portion of a person in order to detect a shuffling state of walking of the person on the basis of an angular acceleration around the horizontal axis from side to side of the waist is detected. Specifically, a frequency analysis is applied to an angular acceleration signal detected by the acceleration sensor, and it is determined that walking of the person is in a shuffling state on the basis of a value of a peak level exists at a double frequency component of the angular acceleration signal.

During normal walking, in accordance with a step forward motion and a push-off back motion, because same rotation occurs on the basis of both motions, when frequency analysis is applied to the angular acceleration signal, a large peak is shown for each double frequency component of the angular acceleration signal. However, in shuffling state, because the push-off back motion weakens, the level of the peak that is shown for each double frequency component diminishes.

According to a known technology disclosed in JP2005114537A, an acceleration sensor is attached to the waist portion in order to estimate a walking speed and a walking stride as a walking speed ability. Specifically, a difference between the bottom peak and the top peak of the acceleration component in the advancing direction, and a difference between the top peak and the bottom peak of the acceleration component in the vertical direction is calculated, and the calculated differences are compared to a predetermined difference and to a relational formula with the walking speed.

More specifically, markers are attached to the person's body, and a camera captures motion image of the walking movement of the person. A track of each marker is measured in order to obtain moving positions and moving times of the markers and compared to a predetermined information. On the basis of the comparison, the walking speed and the walking stride are estimated by use of the measured moving positions and the moving times.

According to the technology disclosed in JP10165395A, a peak of an acceleration is detected in order to determine a stumbling, however, a walking ability of the person itself is not detected or not even estimated.

According to the technology disclosed in JP2000006608A, because the rotation at the waist portion depends on not only the movement at the lower limb but also the movement at the upper limb, even when the level of the peak that is shown for each double frequency component is relatively low, it is difficult to say that such decline directly relates to a walking ability. Further, even if the shuffling state is detected in order to determine whether or not the lower limb declines, a walking ability itself is not detected or even estimated.

According to a technology disclosed in JP2005114537A, a walking speed or a walking stride is estimated as a walking ability, and it is clear that there is a correlative relation between a difference between a top peak and a bottom peak of each acceleration element, however, this is a result of tests executed on only two test subject, and not sufficient results of the test subjects. Further, because each acceleration is not detected at each of right and left legs, it is hard to say that such walking ability is quantified.

A need thus exists to provide a walking analyzer and a walking analyzing method estimating a walking ability in general.

### SUMMARY OF THE INVENTION

According to an aspect of the present invention, a walking analyzer includes an acceleration sensor detecting an up-down acceleration, a front-rear acceleration, and a right-left acceleration of a person, the up-down acceleration including an acceleration in an up-down direction at a waist portion while the person is walking, the front-rear acceleration including an acceleration in a front-rear direction at the waist portion while the person is walking, and the right-left acceleration including an acceleration in a right-left direction at the waist portion while the person is walking, an acceleration change calculating device for calculating changes of each acceleration in time, the each acceleration being detected by the acceleration sensor, a time period extracting device extracting a certain time period in which a certain walking movement is performed on the basis of the changes of the acceleration in time of one of the up-down acceleration, the front-rear acceleration and the right-left acceleration, an estimated indicator calculating device calculating an estimated indicator related to a walking ability on the basis of the changes in the time during the certain time period of the one of the up-down acceleration, the front-rear acceleration and the right-left acceleration; and a walking ability estimating device estimating a walking ability by use of the estimated indicator calculated by the estimated indicator calculating device and by use of a predetermined relation between an estimated indicator and a walking ability.

According to another aspect of the present invention, a walking analyzing method includes an acceleration measuring step detecting an up-down acceleration, a front-rear acceleration, and a right-left acceleration of a person, the up-down acceleration including an acceleration in an up-down direction at a waist portion while the person is walking, the front-rear acceleration including an acceleration in a front-rear direction at the waist portion while the person is walking, and the right-left acceleration including an acceleration in a right-left direction at the waist portion while the person is walking, a acceleration change calculating step for calculating changes of each acceleration in time, the each acceleration being detected by the acceleration sensor, a time period extracting step extracting a certain time period in which a certain walking movement is performed while walking on the basis of the changes in the time of one of the up-down acceleration, the front-rear acceleration and the right-left acceleration, an estimated indicator calculating step calculating an estimated indicator related to a walking speed or a walking stride while walking on the basis of the changes in the time during the certain time period of one of the up-down acceleration, the front-rear acceleration and the right-left acceleration; and one of a walking speed estimating step and a walking stride estimating step, a walking speed estimating step estimating a walking speed by use of the estimated indicator calculated by the estimated indicator calculating step and by use of a predetermined relation between an estimated indicator and a walking speed, and a walking stride estimating step estimating a walking stride by use of the estimated indicator calculated by the estimated indicator calculating step and by use of a predetermined relation between an estimated indicator and a walking stride.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a block diagram indicating an example of a walking analyzer related to the present invention;

FIG. 2 illustrates graphs indicating an example of an acceleration-dorsiflexion force relation;

FIG. 3 illustrates a diagram for explaining walking movements

FIG. 4 illustrates a diagram for explaining how to regulate a level of a dorsiflexion force in a first embodiment;

FIG. 5 illustrates a graph indicating waveforms of changes with time of acceleration signals according to the first embodiment;

FIG. 6 illustrates a graph for explaining dorsiflexion angles of persons who has different dorsiflexion forces;

FIG. 7 illustrates waveforms of changes with time of acceleration signals and related walking movements;

FIG. 8 illustrates an example of an acceleration-lower limb muscle strength relation according to a second embodiment;

FIG. 9 illustrates an example of the acceleration-lower limb muscle strength relation according to the second embodiment;

FIG. 10 illustrates an example of the acceleration-lower limb muscle strength relation according to the second embodiment;

FIG. 11 illustrates an example of the acceleration-lower limb muscle strength relation according to the second embodiment;

FIG. 12 illustrates an example of the acceleration-lower limb muscle strength relation according to the second embodiment;

FIG. 13 illustrates an example of the acceleration-lower limb muscle strength relation according to the second embodiment;

FIG. 14 illustrates an explanation diagram indicating a time of one step and a deceleration time according to a third embodiment;

FIG. 15 illustrate a diagram indicating an example of a relation between an estimated indicator V1 and a walking speed/body height;

FIG. 16 illustrates an integrated value of a front-rear acceleration during a time period between a point at which the front-rear acceleration changes from positive to negative and a point at which the front-rear acceleration changes negative to positive according to the third embodiment;

FIG. 17 illustrates an example of a relation between an estimated indicator V2 and a walking speed/body height;

FIG. 18 illustrates an explanation diagram indicating a breaking period, an accelerating period and a later stage of the mid-stance according to the third embodiment;

FIG. 19 illustrates an example of a relation between an estimated indicator V3 and a walking speed/body height;

FIG. 20 illustrates a diagram for explaining a point at which a walking speed is its maximum during the time of one step and a point at which a walking speed is its minimum during the time of one step according to the third embodiment;

FIG. 21 illustrates an example of a relation between an estimated indicator V4 and a walking speed/body height;

FIG. 22 illustrates an explanation diagram indicating a breaking period, an accelerating period, a later stage of the mid-stance and a range indicated by an estimated indicator V5;

FIG. 23 illustrates a diagram indicating an example of a relation between the estimated indicator V5 and a walking speed/body height according to the third embodiment;

FIG. 24 illustrates an explanation diagram indicating a breaking period, an accelerating period, an early stage of the mid-stance, a later stage of the mid-stance and a range indicated by an estimated indicator V6;

FIG. 25 illustrates a diagram indicating an example of a relation between the estimated indicator V6 and a walking speed/body height according to the third embodiment;

FIG. 26 illustrates a diagram indicating an example of a relation between an estimated indicator V7 and a walking speed/body height;

FIG. 27 illustrates a diagram indicating an example of a relation between an estimated walking speed/body height and an actual walking speed/body height;

FIG. 28 illustrates a diagram indicating an example of a relation between an estimated walking speed/body height and an actual walking speed/body height;

FIG. 29 illustrates an explanation diagram indicating a foot-bottom landing-on and a toe-off;

FIG. 30 illustrates a diagram indicating an example of a relation between an estimated indicator S1 and a walking stride/body height;

FIG. 31 illustrates a diagram indicating an example of a relation between an estimated indicator S2 and a walking stride/body height;

FIG. 32 illustrates a diagram indicating an example of a relation between an estimated indicator S3 and a walking stride/body height;

FIG. 33 illustrates an explanation diagram indicating a heel-strike and a toe-off;

FIG. 34 illustrates a diagram indicating a relation between an estimated walking stride/body height and an actual walking stride/body height; and

FIG. 35 illustrates a diagram indicating a relation between an estimated walking stride/body height and an actual walking stride/body height.

FIG. 36 is a table which shows criteria for determining a person's risk of fall in grade mode after his/her normal speed walking.

FIG. 37 is a table which shows criteria for determining a person's risk of fall in grade mode after his/her maximum speed walking.

### DETAILED DESCRIPTION

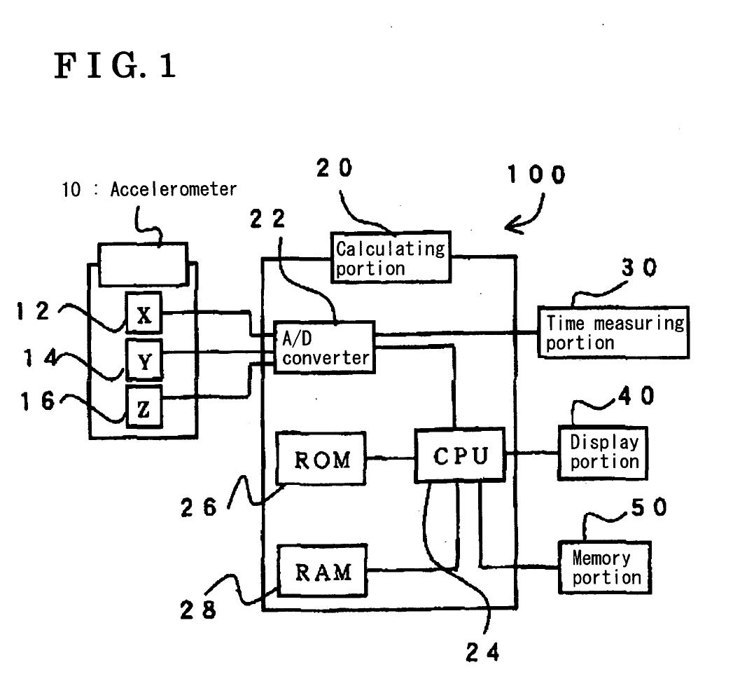

Embodiments of the present invention will be explained in accordance with the attached drawings. FIG. 1 illustrates a block diagram indicating an example of a walking analyzer related to the present invention.

A device 100 illustrated in FIG. 1 includes an accelerometer 10, a calculating portion 20, a time measuring portion 30, a display portion 40 serving as a display means and a memory portion 50. Specifically, the accelerometer 10 serving as an acceleration measuring means detects an acceleration at the person's waist portion while the person is walking, and on the basis of the detected acceleration, the accelerometer 10 outputs an acceleration signal.

The calculating portion 20 estimates a walking ability of the person on the basis of the acceleration signal outputted from the accelerometer 10. The time measuring portion 30 measures the walking time period of the person, and the display portion 40 displays information of the estimated walking ability, the person's information and the like. The memory portion 50 memorizes information related to the result of the level of the walking ability, the person's information and the like.

The accelerometer 10, the calculating portion 20, the time measuring portion 30, the display portion 40 and the memory portion 50 are integrated so as to be temporary attached to, for example the waist portion of a human body. Specifically, the accelerometer 10, the calculating portion 20, the time measuring portion 30, the display portion 40 and the memory portion 50 are integrated into a small device such as a pedometer so as to be hooked at a belt, pants or a skirt.

The accelerometer 10 is comprised of an x-direction acceleration detecting portion 12, a y-direction acceleration detecting portion 14 and a z-direction acceleration detecting portion 16. The x-direction acceleration detecting portion 12 serves as a front-rear acceleration detecting portion for detecting a front-rear acceleration at the waist portion of the person while the person is walking. The y-direction acceleration detecting portion 14 serves as a right-left acceleration detecting portion for detecting a right-left acceleration at the waist portion of the person while the person is walking. The z-direction acceleration detecting portion 16 serves as an up-down acceleration detecting portion for detecting a right-left acceleration at the waist portion of the person while the person is walking. Each detecting portions are integrated into the accelerometer 10, and the accelerometer 10 attached to the waist portion of the person detects all of the front-rear acceleration, the right-left acceleration and the up-down acceleration.

The front-rear acceleration is changed into a front-rear acceleration signal, and the front-rear acceleration signal is outputted into the calculating portion 20. The right-left acceleration is changed into a right-left acceleration signal, and the right-left acceleration signal is outputted into the calculating portion 20. The up-down acceleration is changed into an up-down acceleration signal, and the up-down acceleration signal is outputted into the calculating portion 20. A generally known acceleration sensor, for example a triaxial acceleration sensor using a piezoelectric element or a capacitance triaxial acceleration sensor is used as the accelerometer.

If a triaxial acceleration sensor is used as the accelerometer 10, one of the front-rear acceleration detecting portion 12, the right-left acceleration detecting portion 14 and the up-down acceleration detecting portion 16 serve as a detecting element. The accelerometer 10 may use a combination of a single axial or a biaxial acceleration sensor.

The calculating portion 20 is comprised of an A/D converter 22, a CPU 24 serving as a calculating device, a ROM 26 serving as a memory device and a RAM 28. A/D converter 22 transforms the signals outputted from the accelerometer 10 into digital signals, and the digitalized acceleration signals are outputted into each of the CPU 24, the ROM 26 and the RAM 28. The digitalized acceleration signals (the front-rear acceleration signal, the right-left acceleration signal and the up-down acceleration signal) are temporally memorized in the RAM 28 and used for a predetermined process executed by the CPU 24. For example, waveforms of changes with time of the acceleration signals indicating the accelerations at the waist portion of the person are memorized in the RAM 28 together with time information. The waveforms of the changes with time of the acceleration signals for, for example some cycles are memorized in the RAM 28.

The ROM 26 has a program for extracting a timing at which a certain walking movement is started and a certain time period in which a certain walking movement is performed, from the front-rear acceleration signal, the right-left acceleration signal and the up-down acceleration signal temporally memorized in the RAM 28.

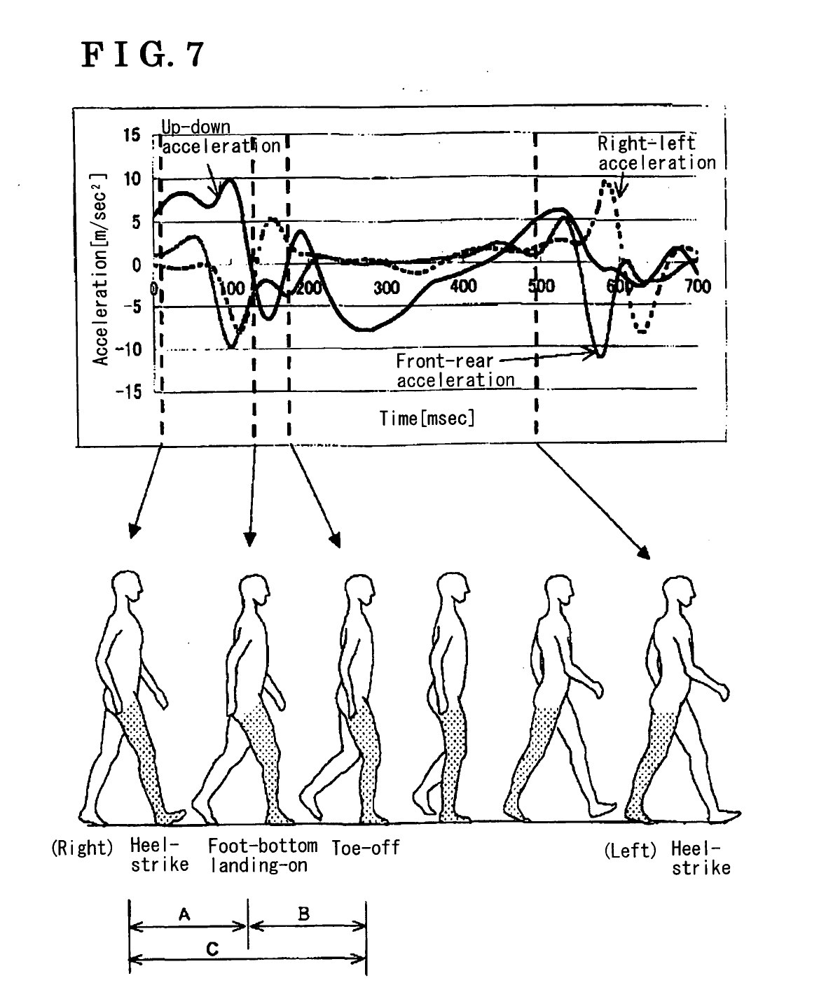

As shown in FIG. 7, the certain walking movement includes a heel-strike, a foot-bottom landing-on, a toe-off, a mid-stance and the like. The heel-strike is a movement in which a heel of one foot contacts the ground, the foot-bottom landing-on is a movement in which an entire plantar of one foot contacts the ground, the toe-off is a movement in which talipes equinus of the other foot leaves the ground.

The program is executed by the CPU 24, and the time period extracting means is comprised of the program, the ROM 26 in which the program is stored, and the CPU 24. A program for calculating an estimated indicator on the basis of each acceleration detected during a certain time period is stored into the ROM 26. The time period is determined as a certain time period by the time period extracting means on the basis of the changes with time of the acceleration signals memorized in the RAM 28. In the same manner as the time period extracting means, the estimated indicator calculating means is comprised of the program and the CPU 24. In the ROM 26, a relation, for example a relational formula between a predetermined estimated indicator and walking ability is stored. A program for estimating the walking ability on the basis of the predetermined relation between an estimated indicator and a walking ability, and on the basis of each estimated indicator calculated at the estimated indicator calculating means. The walking ability estimating means is comprised of the CPU 24 and the program.

The walking analyzer according to the embodiments may include an input-output interface at which data can be exchanged between the walking analyzer and an external portion.

Further, the walking analyzer according to the embodiments may include an input portion through which information of the person can be inputted.

### FIRST EMBODIMENT

A first embodiment of the present invention will be explained. In the first embodiment, a dorsiflexion force is estimated as a walking ability.

As a result of inventor's intensive researches by the inventors of the present invention, it is found that there is a correlative relation between a certain estimated indicator and a level of a dorsiflexion force, a certain estimated indicator being calculated on the basis of changes with time of an acceleration at waist portion during a certain time period in which a certain walking movement while walking has performed.

In other words, a walking analyzer 100 related to the first embodiment includes an acceleration measuring means (accelerometer 10), a time period extracting means (ROM 26, CPU 24), an estimated indicator calculating means (ROM 26, CPU 24) and a walking ability estimating means (ROM 26, CPU 24). Specifically, the acceleration measuring means (accelerometer 10) detects each acceleration in an up-down direction, a front-rear direction and a right-left direction at waist portion while walking.

The time period extracting means (ROM 26, CPU 24) extracts, on the basis of changes with time of at least one of the accelerations, a certain time period in which a certain walking movement, which relates to a level of a dorsiflexion force, has been performed. The estimated indicator calculating means (ROM 26, CPU 24) calculates, on the basis of changes with time of at least one of the accelerations, an estimated indicator that relates to a level of a level of a dorsiflexion force. The walking ability estimating means (ROM 26, CPU 24) estimates a knee extension force on the basis of the estimated indicator calculated by the estimated indicator calculating means, and on the basis of a predetermined relation between an estimated indicator and a level of the dorsiflexion force. The walking ability estimating means includes a memory means (memory device, ROM 26) in which the predetermined relation between an estimated indicator and a level of a dorsiflexion force is memorized.

The estimated indicator may be an average front-rear acceleration during a certain time period. In this case, the level of the dorsiflexion force can be estimated on the basis of a relation between a predetermined average front-rear acceleration and a level of a dorsiflexion force. The average acceleration is obtained by time-integrating changes with time of an acceleration during a certain period, and then the time-integrated value is divided by the certain time period.

According to the walking analyzer of the first embodiment, because a relation between an acceleration at the waist portion while walking and a level of a dorsiflexion force of a human body (hereinbelow referred to as an acceleration-dorsiflexion force relation) is memorized in advance in the memory device, the calculating device determines a level of a dorsiflexion force of the person by detecting an acceleration at the waist portion of the person while walking by the acceleration measuring means and applying the detected acceleration to the memorized acceleration-dorsiflexion force relation.

The reason why there is a correlative relation between an acceleration at the waist portion and a level of a dorsiflexion force will be explained as follows. The dorsiflexion is performed by muscle at the shin (anterior tibial muscle) using an acceleration generated by a push-off back force while walking. If a level of the push-off back force is low, the dorsiflexion force becomes low, and in this case, the toe faces downward. It has been known that the push-off forward movement supports the dorsiflexion movement, and also generates a walking driving force.

Thus, it is considered that there is a correlative relation between an acceleration at the waist portion that relates to a walking driving force and a level of a dorsiflexion force, as a result, a level of a dorsiflexion force can be derived by detecting an acceleration at the waist portion of the person.

Because the acceleration at waist portion generated by the push-off forward movement moves in a front-rear direction, a closer relation exists between the front-rear acceleration at the waist portion and the level of the dorsiflexion force. Thus, an acceleration-dorsiflexion force relation is prepared in advance by calculating a relation between the front-rear acceleration at the waist portion and the level of dorsiflexion force is calculated, an average front-rear acceleration of the detected front-rear acceleration at the waist portion during a certain time period is calculated and set to an estimated indicator, and then a level of a dorsiflexion force of the person is accurately determined on the basis of the estimated indicator referring to the acceleration-dorsiflexion force relation by applying the estimated indicator.

In the first embodiment, because a level of a dorsiflexion force can be estimated, weakening of the lower limb that causes stumbling, which can be a main factor of a fall, can be detected. If the lower limb weakens, because the toe of the leg faces downward during a swing phase (a period in which one leg is moved forward) in one-cycle walking movement (a right step and a left step), enough space is not provided between the toe and the ground. In this condition, stumbling tends to happen resulting in a fall. Thus, a level of a dorsiflexion force can be estimated in order to detect a possibility of stumbling that directly affects a possibility of a fall. If the possibility of stumbling is estimated, the possibility of a fall can be reduced in advance. Further, because the stumbling is a main factor of the fall, the possibility of actual fall is not practically reduced by detecting the stumbling itself. However, according to the walking analyzer of the present invention, because the possibility of stumbling is determined, actions for effectively reducing the possibility of a fall can be provided in advance.

The walking analyzer according to the first embodiment may include means for converting a level of a dorsiflexion force into a certain identification mark, and the walking analyzer may further include a display portion in order to display the identification mark. A numeric value indicating the dorsiflexion force, an identification showing the gradual level of the dorsiflexion force (large, medium, small or other levels), an identification showing whether or not it passes a bench mark (pass or fail, safe or out), and any combination of the above identifications can be used as the identification mark. Further, the walking analyzer may include means for determining whether or not the determined level of a dorsiflexion force is less than a standard. The walking analyzer may also include means for notifying a guidance for preventing a fall if the determined level of the dorsiflexion force is less than the standard.

Further, because the walking analyzer of the present invention can detect the specific weakening of the lower limb that causes stumbling on the basis of the reduction of the dorsiflexion force, it is specifically detected that muscles related to the level of the dorsiflexion force, for example a muscle force at an anterior tibial muscle, weakens. Thus, when it comes to notifying the person of a guidance for preventing the fall, the person can be notified of a specific way to enhance the muscle that directly relates to the dorsiflexion force, which does not relate to the entire lower limb. Thus, this can be a more effective way to reduce the possibility of a fall.

Further, it is possible to prevent the reduction of the dorsiflexion force by an examination of a specialist such as a physical therapist, or by analyzing the walking by means of a motion capture. If the person sees the specialist, it may be such a hassle to see and ask them, and if the walking of the person is analyzed by means of a motion capture, it may require a large machine. According to the present invention, the reduction of the dorsiflexion force can be easily detected by detecting an acceleration at the waist portion by means of the walking analyzer attached at the waist portion of the person.

More specifically, according to the first embodiment, a certain time period includes, for example, a time period between a point at which one leg performs a push-off forward movement and a point at which the other leg performs a mid-stance. Generally, a driving force generated by the push-off forward movement while walking is most significantly shown in a front-rear acceleration at the waist portion of the person during a period between a point at which one leg performs the push-off forward movement and the other leg performs the mid-stance performed.

Thus, if this time period in which the above walking movement is performed is set to a certain time period, a closer correlative relation exists between the front-rear acceleration at the waist portion during the certain time period and the level of the dorsiflexion force. Thus, if a relation between a front-rear acceleration at the waist portion and a level of a dorsiflexion force during the certain time period is prepared in advance, a dorsiflexion force can be estimated on the basis of a calculated average front-rear acceleration during the certain time period, which is set to an estimated indicator.

A time period between a point where a heel-strike, in which the heel of one leg contacts the ground, is performed, and a point where a foot-bottom landing-on, in which the entire plantar of the other leg contacts the ground, is performed, can be presented may be set to a certain time period. Further, a time period between a point where a heel-strike, in which the heel of one leg contacts the ground, is performed, and a point where a toe-off, in which the toe of the other leg leaves the ground, is performed, may also be set to a certain time period.

As a level of a dorsiflexion force, a rate of change of a dorsiflexion angle at the ankle during a certain time period is set to an indicator. In this case, the level of the dorsiflexion force can be estimated by preparing in advance a relation between an estimated indicator during a certain time period and a rate of change of a dorsiflexion angle. The dorsiflexion angle is formed between a line connecting the ankle joint and the shin (the front part of the leg below the knee and above the ankle) and a line connecting the ankle joint and the toe.

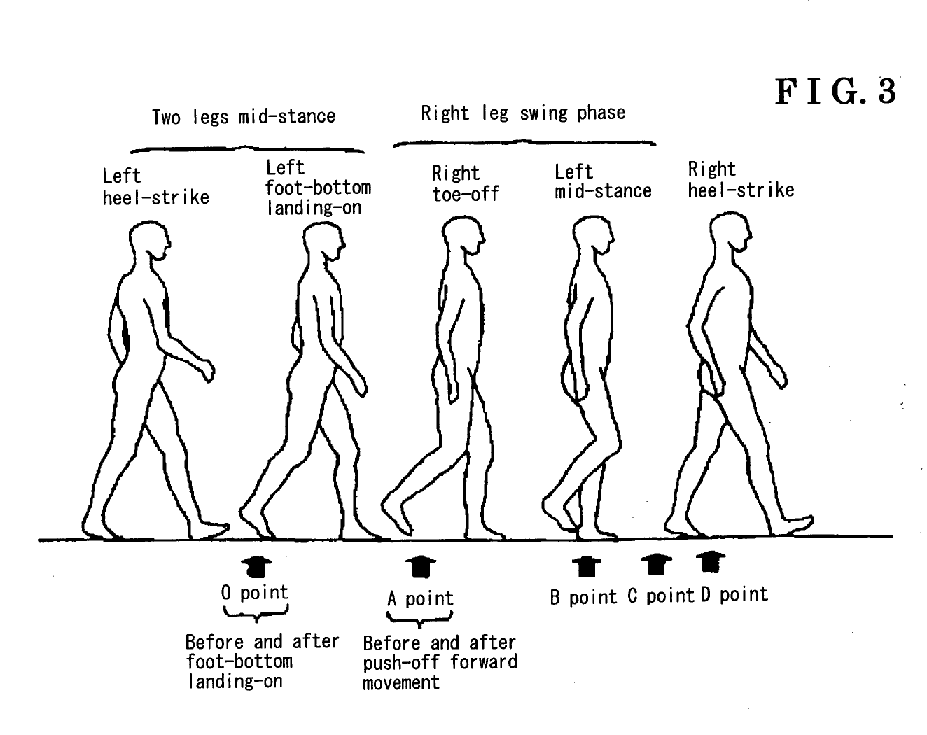

As shown in FIG. 3, referring to one leg (hereinafter referred to as a right leg), a dorsiflexion angle at the right leg is at its minimum during a two legs supporting operation of the walking movement is performed, in which both right and left legs contact the ground. Specifically, the dorsiflexion angle generally is at its minimum during a left plantar contacting movement of the walking movement, in which the entire plantar of the left leg contacts the ground.

More specifically, at the left plantar contacting point where the entire plantar of the left leg contacts the ground, the weight of the person shifts from the left heel toward the left toe. The dorsiflexion angle is at its minimum at a certain point (O point) provided at a point between a midterm of this weight shift operation and a point where a toe-off, in which a tow leaves the ground, is performed. On the other hand, the dorsiflexion angle at right leg generally peaks at a point immediately after the right toe-off is performed as shown in FIG. 3.

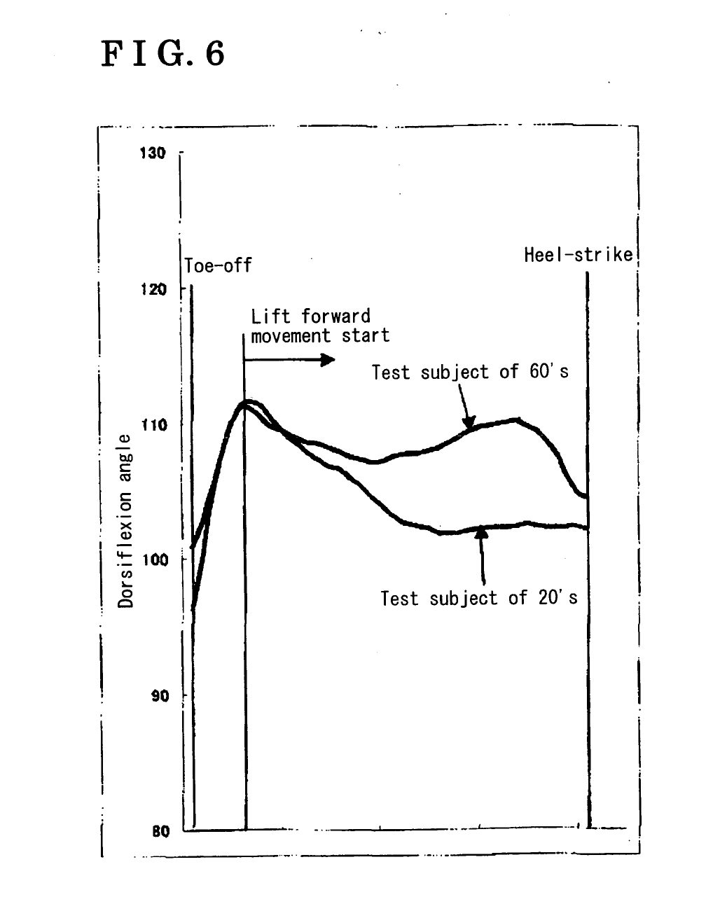

Specifically, after the right leg leaves the ground while the push-off forward movement is performed, the dorsiflexion angle at right leg generally peaks at before and after a right leg lift forward movement (A point). As shown in FIG. 6, in reference to data of a test subject in his/her 60's, when a dorsiflexion force is reduced after the push-off forward movement, because his/her toe face downward, a dorsiflexion angle becomes large. On the other hand, with reference to data of a test subject in his/her 20's, in which a dorsiflexion force is appropriately maintained, after his/her dorsiflexion angle becomes large, the dorsiflexion angle is reduced so as to be small again.

(β−a) indicates a difference between a dorsiflexion angle at O point shown in FIG. 3 (hereinbelow referred to as a) and a dorsiflexion angle at A point shown in FIG. 3 (hereinbelow referred to as β). (β−γ) indicates a difference between the dorsiflexion angle (β) at A point and a dorsiflexion angle (hereinbelow referred to as γ) during a period after a point at which the push-off forward movement is performed to a point at which he right heel-strike is performed (shown in FIG. 3). When the level of the dorsiflexion is large, a ratio of the difference (β−γ) relative to the difference (β−a) becomes large. In other words, when the dorsiflexion force is large, a value obtained by (β−γ)/(β−a) becomes large. On the other hand, when the dorsiflexion force is small, a ratio of β−γ relative to β−a becomes small, as a result, a value obtained by (β−γ)/(β−a) becomes small. Thus, a level of a dorsiflexion force can be evaluated by comparing the value obtained by a formula 1.
(β−γ)/(β−a) Formula 1

Thus, an acceleration-dorsiflexion force relation can be obtained in advance by obtaining the relation between an acceleration at the waist portion and the level of the dorsiflexion force calculated by the formula 1. Specifically, the acceleration-dorsiflexion force relation can be obtained as follows. First, an acceleration at the waist portion while walking, especially a front-rear acceleration during a period between a point at which the push-off forward movement is performed and a point at which the mid-stance is performed is measured, and a dorsiflexion angle while walking is also measured. A level of a dorsiflexion force is calculated by the formula 1 using the obtained dorsiflexion angle. Then, a relation between the calculated level of the dorsiflexion force and the acceleration at the waist portion is expressed by a function or the like; and this function indicates an acceleration-dorsiflexion force relation.

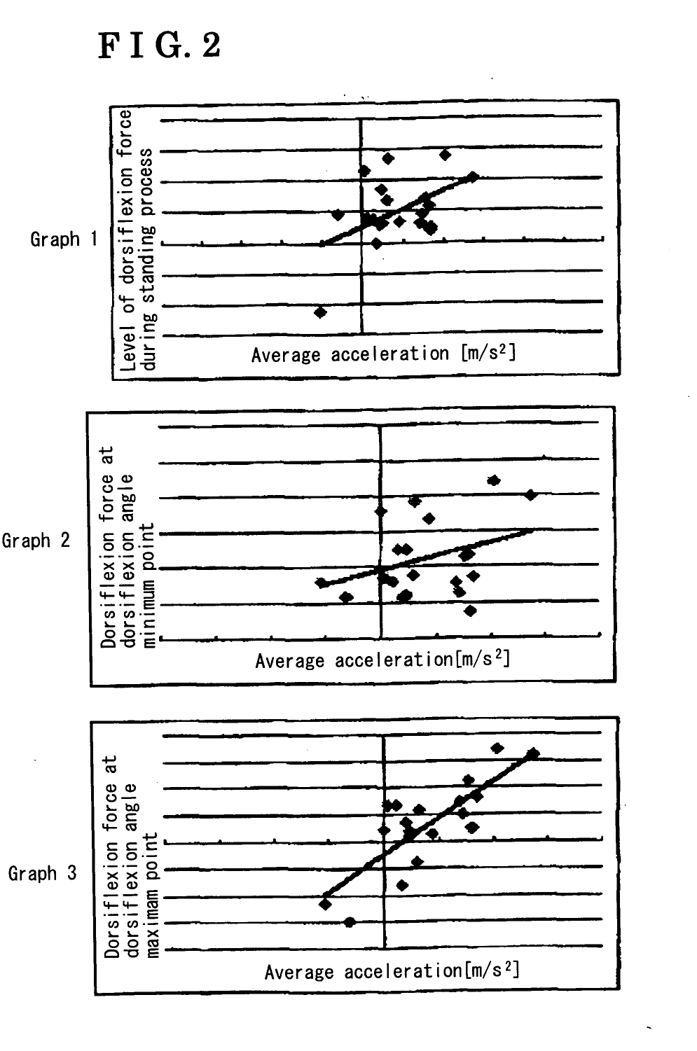

In the first embodiment, an acceleration-dorsiflexion force relation, which is calculated in advance, is memorized in the ROM 25. Examples of the acceleration-dorsiflexion force relation memorized in ROM 26 are illustrated in graphs in FIG. 2. A straight line illustrated in each graph indicates the acceleration-dorsiflexion force relation.

Each acceleration-dorsiflexion force relation determines a relation between an average acceleration of a front-rear acceleration during a certain time period between a point at which the push-off forward movement is performed and a point at which the left mid-stance (shown in FIG. 3) is performed (hereinbelow referred to as simply an average front-rear acceleration) and a level of a dorsiflexion force. In this embodiment a level of a dorsiflexion force is determined by the formula 1 (β−γ)/(β−a).

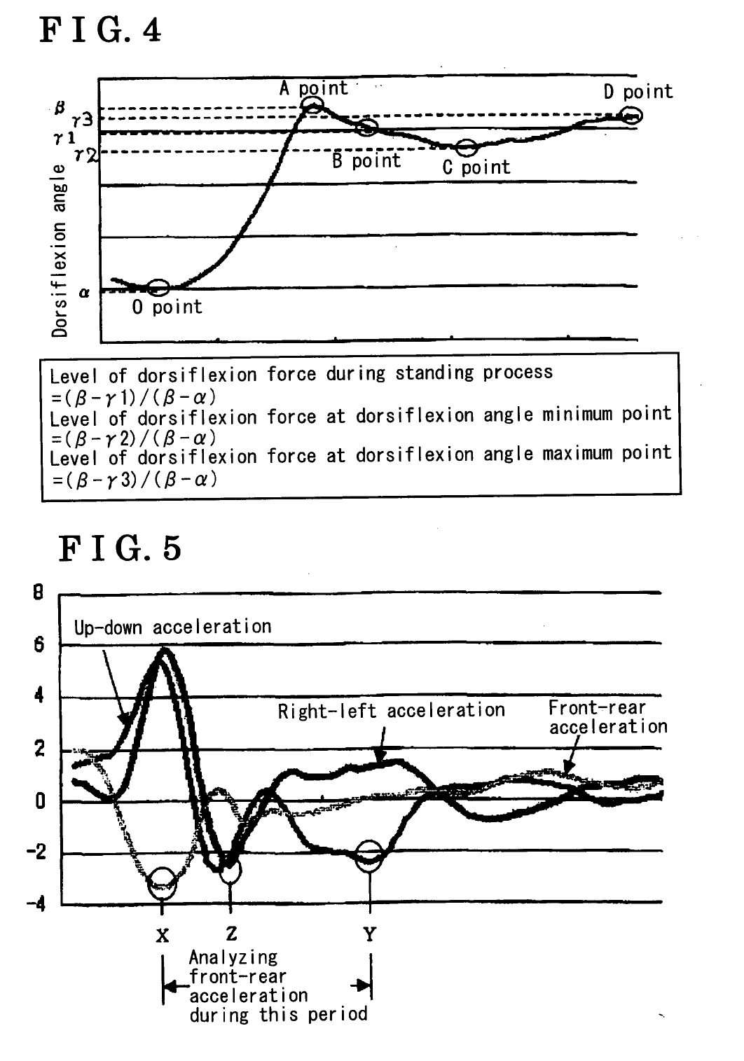

As shown in FIG. 4, a dorsiflexion angle at O point at which a dorsiflexion angle becomes minimum is indicated by a, a dorsiflexion angle at A point at which a dorsiflexion angle becomes maximum is indicated by β, and a dorsiflexion angle on and after a swing phase, approximately corresponding to a period between a point at which the push-off forward operation is performed and a point at which the right heel-strike is performed, is indicated by γ.

The O point corresponds to a point before and after the left plantar contacting point during the two legs mid-stance shown in FIG. 3. The A point corresponds a point before and after of the lift forward operation shown in FIG. 3. The dorsiflexion angle γ includes a dorsiflexion angle γ1 at B point, a dorsiflexion angle γ2 at C point and a dorsiflexion angle γ3 at D point. The vertical axis in each graph in FIG. 2 indicates a level of a dorsiflexion force obtained by the formula 1, and the horizontal axis in each graph in FIG. 2 indicates an average acceleration.

The graph 1 in FIG. 2 indicates a relation between the average acceleration and a level of a dorsiflexion force during the mid-stance immediately after the push-off forward movement. The level of a dorsiflexion force during the mid-stance indicates a level of a dorsiflexion force during a left mid-stance (B point, a right mid-stance when the push-off forward movement is performed by a left leg), and the level of a dorsiflexion force during the mid-stance corresponds to a value which is obtained by the formula 1 using a dorsiflexion angle γ1 at the B point shown in FIG. 4 (the left mid-stance in FIG. 3) instead of the dorsiflexion angle γ. Specifically, referring to the acceleration-dorsiflexion force relation indicated in the graph 1, a level of a dorsiflexion force during the mid-stance is determined on the basis of the average acceleration.

The graph 2 in FIG. 2 indicates a relation, during a period between a point at which the push-off forward movement is performed and a point at which the right heel-strike is performed, between an average acceleration and a level of a dorsiflexion force at a dorsiflexion angle minimum point at which a dorsiflexion angle becomes minimum. A level of a dorsiflexion force at a dorsiflexion angle minimum point is a level of a dorsiflexion force at point where a dorsiflexion angle becomes minimum during the right leg swing phase illustrated in FIG. 3, and a level of a dorsiflexion force at a dorsiflexion angle minimum point corresponds to a value which is obtained by the formula 1 using a dorsiflexion angle γ2 at the C point illustrated in FIG. 4 in stead of the dorsiflexion angle γ. Referring to the acceleration-dorsiflexion force relation shown in the graph 2, a level of a dorsiflexion force at a dorsiflexion angle minimum point, during a period between a point at which the right leg swing is performed and a point at which the right heel-strike is performed, is estimated on the basis of the detected average acceleration.

The graph 3 illustrates a relation between an average acceleration and a level of a dorsiflexion force at a dorsiflexion angle maximum point. A level of a dorsiflexion force at a dorsiflexion angle maximum point indicates a level of a dorsiflexion force at a point at which a dorsiflexion angle becomes maximum again on and after the right leg swing phase, which includes a period between the point A and a point at which the right heel-strike is performed. A level of a dorsiflexion force at a dorsiflexion angle maximum point corresponds to a value which is obtained by the formula 1 using a dorsiflexion angle γ3 at the D point illustrated in FIG. 4 in stead of the dorsiflexion angle γ. Thus, referring to the acceleration-dorsiflexion force relation shown in the graph 3, a level of a dorsiflexion force at a dorsiflexion angle maximum point can be estimated on the basis of the average acceleration.

The acceleration-dorsiflexion force relations can be obtained as follows. First, an acceleration at the waist portion of each of plural test subjects while walking is measured, at the same time, changes of a dorsiflexion angle are measured. Then each level of a dorsiflexion force is calculated by the formula 1.

On the basis of plural data each of which is a combination of the measured acceleration and the calculated level of the dorsiflexion force (corresponding to each dot in FIG. 2), a relation between the acceleration and the level of the dorsiflexion force (corresponds to a straight line in FIG. 2) can be obtained by applying a least squares method or the like to them.

Among the graphs illustrated in FIG. 2, it is considered that the relation is shown most clearly between the average acceleration and a level of a dorsiflexion force at a dorsiflexion angle maximum point. Thus, according to the acceleration-dorsiflexion force relation in this embodiment, a level of a dorsiflexion force at a dorsiflexion angle maximum point may be served as a typical level of a dorsiflexion force on and after the push-off forward movement.

Another indicator that is not obtained by the formula 1 may be used as a level of a dorsiflexion force. In this case, a dorsiflexion force at any point except D point, at which a dorsiflexion angle peaks, may have a closer relation to the average acceleration. In this case, the level of the dorsiflexion force at this point may be used as a typical indicator.

An actuation and a movement of the walking analyzer 100 in the first embodiment will be explained. When the person having the walking analyzer 100 at his/her waist portion starts walking, the accelerometer 10 of the walking analyzer 100 measures a front-rear acceleration, a right-left acceleration and an up-down acceleration in order to calculate changes with time thereof.

The accelerometer 10 outputs the changes with time of each acceleration as a waveform electric signal (acceleration signal). The acceleration signal is digitalized by an A/D converter 22, and the digital signal is temporally memorized in the RAM 28.

The graph illustrated in FIG. 5 indicates examples of changes with time of the acceleration signals (the front-rear acceleration signal, the right-left acceleration signal and the up-down acceleration signal), which are detected at the accelerometer 10. As shown in this graph, each acceleration changes as time passes.

In the graph illustrated in FIG. 5, the front-rear acceleration is illustrated in a manner where its frontward direction is positive (as in “positive +, everything above 0” and “negative −, everything below 0”), the right-left acceleration is illustrated in a manner where its rightward direction is positive, and the up-down acceleration is illustrated in a manner where its upward direction is positive. The changes with time of each acceleration correspond to a certain walking movement of the walking movement.

After the acceleration signals (the front-rear acceleration, the right-left acceleration and the up-down acceleration) corresponding to one cycle of the walking movement are memorized in the RAM 28, the time period extracting means extracts a timing and a time period (a certain time period), in which the certain walking movement is performed, from the changes with time of the acceleration signals. The time period extracting means is comprised of the CPU 24 and the ROM 26.

Specifically, a peak of the acceleration signal is detected on the basis of a time derivative of the acceleration signal, and it is determined that a certain walking movement starts or ends at the peak.

For example, as shown in FIG. 5, it can be determined that the push-off forward movement illustrated in FIG. 3 is performed at a point (X point) at which the front-rear acceleration becomes minimum, and the up-down acceleration and the right-left acceleration become maximum. Further, it can be determined that, on and after the push-off forward movement, the right toe-off (when the push-off forward movement is performed by the right leg) in FIG. 3 is performed at a point (Z point) at which the up-down acceleration and the right-left acceleration are minimum.

Furthermore, after the toe-off, the up-down acceleration and the right-left acceleration are gradually increased, however, the up-down acceleration is gradually decreased so as to reach a minimum value. It can be determined that the right mid-stance (when the right push-off forward movement is performed by the right leg) is performed at a point (Y point) at which the up-down acceleration becomes minimum.

Because points at which a certain walking movement is performed are determined as mentioned above, on the basis of at least two of these points, a certain time period in which the certain walking movement is performed can be extracted. On the basis of changes with time of the accelerations within the certain time period, the CPU 24 calculates an average front-rear acceleration. Specifically, within the certain time period between a point at which the push-off forward movement is determined and a point at which the mid-stance is determined, on the basis of changes with time of the front-rear acceleration, an average acceleration in a front-rear direction is calculated and set to an estimated indicator.

On the basis of the estimated indicator, a level of a dorsiflexion force is estimated referring to the acceleration-dorsiflexion force relation. Specifically, the CPU 24 applies the calculated average acceleration to the acceleration-dorsiflexion force relation memorized in the ROM 26 as shown in FIG. 2, and as a result, a level of a dorsiflexion force corresponding to the average acceleration can be obtained.

The level of a dorsiflexion force is obtained by the formula 1. A level of a dorsiflexion force at a mid-stance, a level of a dorsiflexion force at a dorsiflexion angle minimum point, and a level of a dorsiflexion force at a dorsiflexion angle maximum point shown in FIG. 2 are calculated and memorized in the RAM 28 in advance. The level of the dorsiflexion force may be automatically memorized in the memory portion 50 as a calculation result.

Further, on the basis of the estimated level of a dorsiflexion force, a walking age (referring to a walking ability of the person) of the person at this point may be calculated. Specifically, a relation between a level of a dorsiflexion force and a walking age is prepared and memorized in the ROM 26 in advance, and a walking age of the person is calculated by applying a calculated level of a dorsiflexion force to the relation between a level of a dorsiflexion force and a walking age. The calculated walking age may be temporally memorized in the RAM 28, or the walking age may be automatically stored in the memory portion 50.

After the level of a dorsiflexion force is obtained at CPU 24 by use of the formula 1, the obtained result may be displayed on the display portion 40. In this case, the person may be able to select the items to display from a level of a dorsiflexion force at a mid-stance, a level of a dorsiflexion force at a dorsiflexion angle minimum point, and a level of a dorsiflexion force at a dorsiflexion angle maximum point; and the estimated result of the selected item may be displayed on the display. All the estimated results may be automatically displayed on the display.

Further, a walking age obtained on the basis of the estimated level of a dorsiflexion force may be displayed on the display. Furthermore, it is possible to display a guidance of exercises to prevent a fall depending on the walking age so that the person can follow the guidance.

According to the walking analyzer 100 of the first embodiment, because a level of a dorsiflexion force of the person can be estimated as a walking ability, weakening of the lower limb that causes stumbling, which can be a main factor of a fall, can be detected. Further, because decline of the dorsiflexion force, which generally leads the stumbling, can be directly detected, it is possible that some measures to prevent the stumbling is taken earlier than when the measures are taken on the basis of the stumbling itself.

### SECOND EMBODIMENT

A second embodiment of the present invention will be explained. In the second embodiment, a level a lower limb muscle strength is estimated as walking ability. As a result of inventor's intensive researches by the inventors of the present intention, it is found that there is a correlative relation between a certain estimated indicator and a level of a lower limb muscle strength, a certain estimated indicator being calculated on the basis of changes with time of an acceleration at waist portion during a certain time period in which a certain walking movement while walking has performed.

In other words, a walking analyzer 100 related to the first embodiment includes an acceleration measuring means (accelerometer 10), a time period extracting means (ROM 26, CPU 24), an estimated indicator calculating means (ROM 26, CPU 24) and a walking ability estimating means (ROM 26, CPU 24). Specifically, the acceleration measuring means (accelerometer 10) detects each acceleration in an up-down direction, a front-rear direction and a right-left direction at waist portion while walking.

The time period extracting means (ROM 26, CPU 24) extracts, on the basis of changes with time of at least one of the accelerations, a certain time period in which a certain walking movement, which relates to a level of a lower limb muscle strength, has been performed. The estimated indicator calculating means (ROM 26, CPU 24) calculates, on the basis of changes with time of at least one of the accelerations, an estimated indicator that relates to a level of a lower limb muscle strength.

The walking ability estimating means (ROM 26, CPU 24) estimates a lower limb muscle strength referring to a predetermined relation between an estimated indicator and a level of the lower limb muscle strength by use of the estimated indicator calculated by the estimated indicator calculating means. The walking ability estimating means includes a memory means (memory device, ROM 26) in which the predetermined relation between an estimated indicator and a level of a lower limb muscle strength is memorized.

The estimated indicator may be an average front-rear acceleration during the certain time period. In this case, the level of lower limb muscle strength can be estimated by preparing a relation between an average front-rear acceleration and a level of lower limb muscle strength in advance.

The lower limb muscle strength can be estimated by measuring changes with time of an acceleration at the waist portion of the person while walking on the basis of the following reasons. A front-rear acceleration at the waist portion of the person while walking corresponds to a driving force and a braking force in a front-rear direction, which are obtained by the lower limb muscle strength. Thus, it is considered that there is a closer correlative relation between a front-rear acceleration at the waist portion and a level of the lower limb muscle strength.

Thus, a relation between a front-rear acceleration at the waist portion and a lower limb muscle strength is calculated and prepare in advance as an acceleration-lower limb muscle strength relation, an average front-rear acceleration during a certain time period is calculated and set to an estimated indicator, and a lower limb muscle strength is measured referring to the acceleration-lower limb muscle strength relation on the basis of the estimated indicator.

The person walks forward in a manner where his/her one leg push-off forward. A force used for this push-off forward movement moves in a front-rear direction and an up-down direction. Thus, it is considered that there is a correlative relation between the level of the lower limb muscle strength corresponding to the force used for the push-off forward movement and an up-down acceleration at the waist portion while walking.

Thus, a relation between an up-down acceleration at the waist portion and a level of the lower limb muscle strength is calculated in advance as an acceleration-lower limb muscle strength relation, an average up-down acceleration during the certain time period is calculated and set to an estimated indicator, and a lower limb muscle strength of the person is measured referring to the acceleration-lower limb muscle strength relation on the basis of the estimated indicator.

Further, when a lower limb muscle strength is measured on the basis of a front-rear acceleration or an up-down acceleration, a time period between a point at which one leg performs the heel-strike and a point at which one leg performs the foot-bottom landing-on is set to a certain time period. Specifically, the heel-strike is a movement in which the heel of one leg contacts the ground, and the foot-bottom landing-on is a movement in which the entire plantar of one leg contacts the ground. When the heel-strike is performed, an appropriate level of the lower limb muscle strength (e.g., a lower limb muscle strength) that is able to withstand a bending moment generated in the vicinity of the ankle is needed. The bending moment is a moment for rotating the ankle by an actuation from the ground in a direction where the toe contacts the ground. Because the bending moment becomes large when the level of the walking speed is large while the heel contacts the ground, and when the lower limb muscle strength is small, in order to set the bending moment as a tolerable value, the walking speed while the heel contacts the ground is reduced.

On the other hand, when the lower limb muscle strength is large, because a large bending moment can be tolerated, the walking speed while the heel contacts the ground is increased. Thus, it is considered that a lower limb muscle strength can be estimated by setting a front-rear acceleration at the waist portion when the heel-strike is performed to an estimated indicator. When the heel-strike is performed, an appropriate level of the lower limb muscle strength (e.g., a lower limb muscle strength) that is able to withstand a bending moment generated in the vicinity of the knee joint is needed. The bending moment is a moment for rotating the knee joint by an actuation from the ground in a direction where the knee is bent. Because the bending moment becomes large when the level of the walking speed is large while the heel contacts the ground, when the lower limb muscle strength is small, in order to set the bending moment as a tolerable value, the walking speed while the heel contacts the ground is reduced.

On the other hand, when the lower limb muscle strength is large, a large bending moment is tolerated; the walking speed while the heel contacts the ground is increased. Thus, it is considered that a lower limb muscle strength can be estimated by setting a front-rear acceleration at the waist portion when the heel-strike is performed to an estimated indicator. Further, when the level of the lower limb muscle strength is low, because it generally is not able to withstand a bending moment generated when the heel contacts the ground, the person tends to perform the heel-strike in a manner where his/her knee joint is extended so as not to bend the knee.

When the person performs the heel-strike in a manner where the person's knee joint is extended, an impact from the ground generated when the heel contacts the ground cannot be absorbed at knee joint. This impact from the ground affect the up-down acceleration at the waist portion. Specifically, when the level of the impact is large, assuming that an upper direction is positive, the up-down acceleration is increased. More specifically, it is considered that, when the level of the lower limb muscle strength is low, the level of the up-down acceleration when the heel-strike is performed is increased. On the other hand, the level of the lower limb muscle strength is large, it generally is able to withstand the bending moment generated when the heel-strike is performed, the person tends to perform the heel-strike bending his/her knee joint so as to absorb the impact.

Thus, when the level of the lower limb muscle strength is high, the level of the impact from the ground decreases. In other words, the level of the up-down acceleration when the heel-strike is performed decreases. Thus, the level of the lower limb muscle strength can be estimated by detecting the acceleration at the waist portion during the heel-strike.

In the same manner, when a lower limb muscle strength is measured on the basis of a front-rear acceleration or an up-down acceleration, a time period between a point at which one leg performs the foot-bottom landing-on and a point at which the other leg performs the toe-off is set to a certain time period. Specifically, the foot-bottom landing-on is a movement in which the entire plantar of one leg contacts the ground, and the toe-off is a movement in which the toe of the other leg leaves the ground.

An acceleration at the waist portion during the certain time period relates to a braking ability while the walking movement is performed. Because it is considered that the braking ability is reduced when the level of lower limb muscle strength is low, the lower limb muscle strength can be measured by detecting an acceleration at the waist portion during the certain time period.

Specifically, during the certain time period, the front-rear acceleration at the waist portion turns negative, indicating a speed reduction. The larger an absolute value of the negative front-rear acceleration becomes, the larger the braking ability becomes. In other words, when the absolute value of the negative front-rear acceleration is large it can be determined that the level of the lower limb muscle strength is large.

On the other hand, the smaller an absolute value of the negative front-rear acceleration becomes, the smaller the braking ability becomes. In other words, when the absolute value of the negative front-rear acceleration is small, it can be determined that the level of the lower limb muscle strength is small.

In the same manner as the above, when a lower limb muscle strength is measured on the basis of a front-rear acceleration or an up-down acceleration, a time period between a point at which one leg performs the heel-strike and a point at which the other leg performs the toe-off is set to a certain time period. Specifically, the heel-strike is a movement in which the heel of one leg contacts the ground, and the toe-off is a movement in which the toe of the other leg leaves the ground. During the certain time period, the walking speed is reduced in totally under the influence of a braking force.

An acceleration at the waist portion during the certain time period relates to a braking ability while the walking movement is performed. Because it is considered that the braking ability is reduced when the level of lower limb muscle strength is low, the lower limb muscle strength can be measured by detecting an acceleration at the waist portion during the certain time period.

Specifically, during the certain time period, the front-rear acceleration at the waist portion turns negative, indicating a speed reduction. The larger an absolute value of the negative front-rear acceleration becomes, the larger the braking ability becomes. In other words, when the absolute value of the negative front-rear acceleration is large it can be determined that the level of the lower limb muscle strength is large.

On the other hand, the smaller an absolute value of the negative front-rear acceleration becomes, the smaller the braking ability becomes. In other words, when the absolute value of the negative front-rear acceleration is small, it can be determined that the level of the lower limb muscle strength is small.

Thus, in the second embodiment, a lower limb muscle strength is measured. In the same manner as the lower limb, a dorsiflexion force can also be measured. It is confirmed that there is a correlative relation between a dorsiflexion force and an acceleration at the waist portion. The correlative relation is confirmed for the reasons below. When the walking movement, in which acceleration and deceleration are repeated, is performed, the person uses a dorsiflexion force in order to reduce the walking speed. The dorsiflexion force is one of muscles that are used for reducing the walking speed.

Thus, because an acceleration at the waist portion while the certain walking movement, which corresponds to a braking period in the walking movement, is affected by a braking force, it is considered that there is a correlative relation between an acceleration at the waist portion and a dorsiflexion force. Thus, the dorsiflexion force can be estimated by setting an acceleration at the waist portion during the certain time period to an estimated indicator.

Further, in the same manner as the lower limb, a knee extension force can also be measured. When the walking movement is performed, the person uses a knee extension force in order to generate a braking force. The knee extension force is one of muscles that are used for generating the braking force.

Thus, because an acceleration at the waist portion during a certain time period, which corresponds to a braking period in the walking movement, is affected by a braking force, it is considered that there is a correlative relation between an acceleration at the waist portion and a knee extension force. Thus, the knee extension force can be estimated by setting an acceleration at the waist portion during the certain time period to an estimated indicator.

Specifically, a relation between the estimated indicator on the basis of the changes with time of each acceleration during the certain time period and the knee extension force is obtained in advance, and the knee extension force is estimated referring to the relation on the basis of the calculated estimated indicator.

When the dorsiflexion force and the knee extension force are measured as the lower limb muscle strength, a time period from a point at which one leg performs the heel-strike and a point at which one leg performs the foot-bottom landing-on is set to the certain time period. Specifically, the heel-strike is a movement in which the heel of one leg contacts the ground, the foot-bottom landing-on is a movement in which the entire plantar of one leg contacts the ground, and an average front-rear acceleration during the certain time period is set to an estimated indicator.

Further, a time period between a point at which one leg performs the foot-bottom landing-on and a point at which the other leg performs the toe-off is set to the certain time period. Specifically, the foot-bottom landing-on is a movement in which the entire plantar of one leg contacts the ground, and the toe-off is a movement in which the toe of the other leg leaves the ground, and an average front-rear acceleration during the certain time period is set to an estimated indicator.

Furthermore, a time period between a point at which one leg performs the heel-strike and a point at which one leg performs the foot-bottom landing-on is set to the certain time period. Specifically, the heel-strike is a movement in which the heel of one leg contacts the ground, the foot-bottom landing-on is a movement in which the entire plantar of one leg contacts the ground, and an average up-down acceleration during the certain time period is set to an estimated indicator.

Using combinations of the above accelerations and the lower limb muscle strength, the dorsiflexion force and the knee extension force are estimated more precisely.

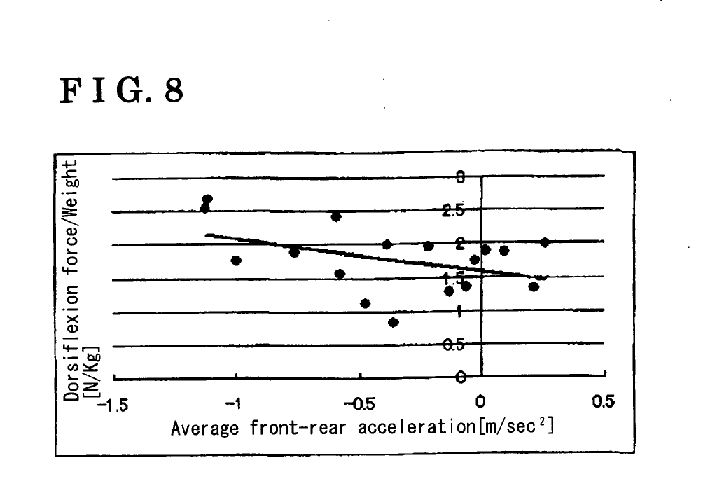

According to the second embodiment, an acceleration-lower limb muscle strength relation, which is prepared in advance, is memorized in the ROM 26. The acceleration-lower limb muscle strength relation memorized in the ROM 26 indicates a relation between a front-rear acceleration and the level of the lower limb muscle strength. Examples of the acceleration-lower limb muscle strength relations are illustrated in FIG. 8 through 13. A straight line in each graph indicates the acceleration-lower limb muscle strength relation.

Specifically, the acceleration-lower limb muscle strength relation indicates a relation between an acceleration at the waist portion while walking and a lower limb muscle strength such as a dorsiflexion force, a knee extension force or the like. The acceleration-lower limb muscle strength relation is obtained by previously calculating a relation between a front-rear acceleration or an up-down acceleration upon a certain walking movement and a lower limb muscle strength such as a dorsiflexion force or a knee extension force.

Specifically, an acceleration (a front-rear acceleration, an up-down acceleration or the like) at the waist portion while walking is measured for plural test subjects, at the same time, a lower limb muscle strength such as a dorsiflexion force or a knee extension force is measured for each test subject. On the basis of plural data each of which is a combination of the measured acceleration and the level of the lower limb muscle strength (each dot in FIGS. 8 through 13), a relation between the acceleration and the level of the lower limb muscle strength (corresponds to each straight line in FIGS. 8 through 13) can be obtained by applying, for example, at least squares method to them.

The acceleration-lower limb muscle strength relations illustrated in FIGS. 8 through 13 will be explained in detail. The acceleration-lower limb muscle strength relation illustrated in FIG. 8 indicates a relation between an average front-rear acceleration and a dorsiflexion force during the certain time period that is indicated with an arrow A (time period A) in FIG. 7 (a time period between the heel-strike and the foot-bottom landing-on). On the basis of the acceleration-lower limb muscle strength relation illustrated in FIG. 8, a dorsiflexion force of the person can be measured by calculating an average front-rear acceleration during the time period A.

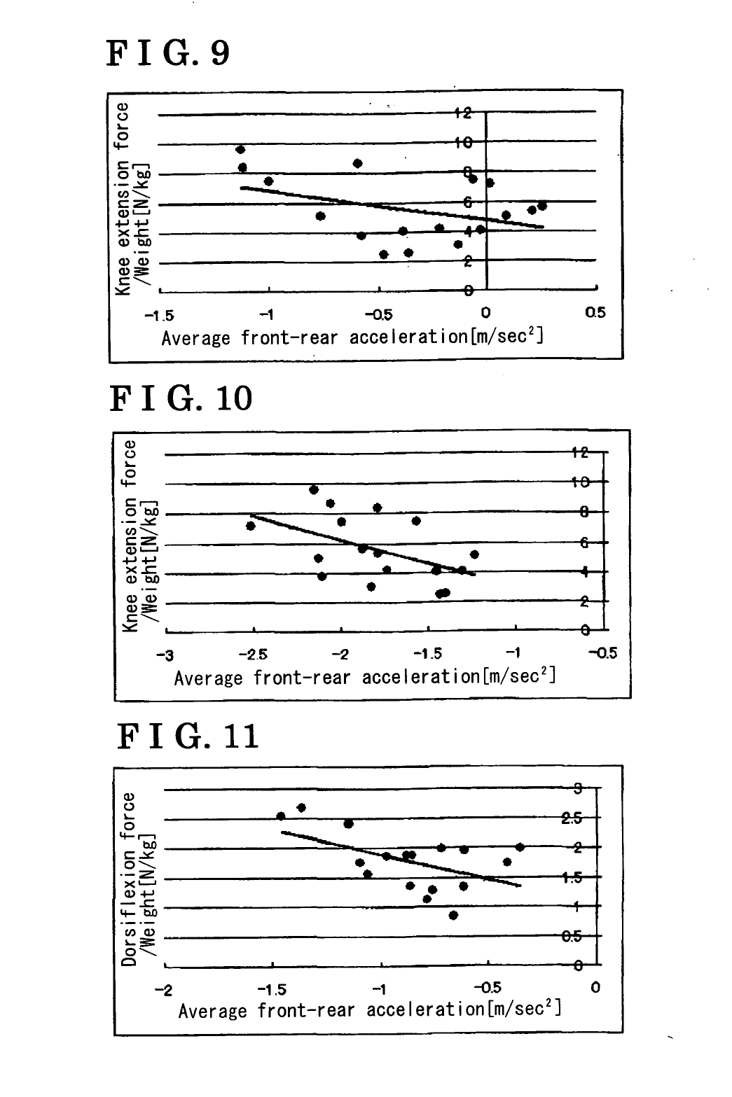

The acceleration-lower limb muscle strength relation illustrated in FIG. 9 indicates a relation between an average front-rear acceleration and a knee extension force during the certain time period that is indicated with the arrow A (time period A) in FIG. 7 (a time period between the heel-strike and the foot-bottom landing-on). On the basis of the acceleration-lower limb muscle strength relation illustrated in FIG. 9, a knee extension force of the person can be measured by calculating an average front-rear acceleration during the time period A.

The acceleration-lower limb muscle strength relation illustrated in FIG. 10 indicates a relation between an average front-rear acceleration and a knee extension force during the certain time period that is indicated with an arrow B (time period B) in FIG. 7 (a time period between the foot-bottom landing-on and the toe-off). On the basis of the acceleration-lower limb muscle strength relation illustrated in FIG. 10, a knee extension force of the person can be measured by calculating an average front-rear acceleration during the time period B.

The acceleration-lower limb muscle strength relation illustrated in FIG. 11 indicates a relation between an average front-rear acceleration and a dorsiflexion force during the certain time period that is indicated with an arrow C (time period C) in FIG. 7 (a time period between the heel-strike and the toe-off). On the basis of the acceleration-lower limb muscle strength relation illustrated in FIG. 11, a dorsiflexion force of the person can be measured by calculating an average front-rear acceleration during the time period C.

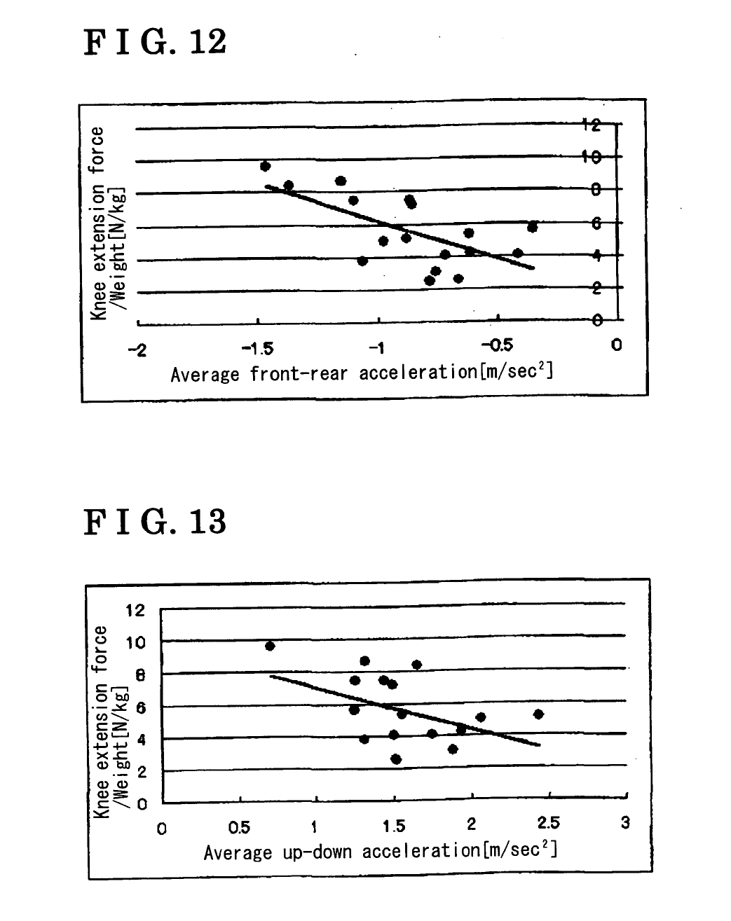

The acceleration-lower limb muscle strength relation illustrated in FIG. 12 indicates a relation between an average front-rear acceleration and a knee extension force during the certain time period that is indicated with the arrow C (time period C) in FIG. 2 (a time period between the heel-strike and the toe-off). On the basis of the acceleration-lower limb muscle strength relation illustrated in FIG. 12, a knee extension force of the person can be measured by calculating an average front-rear acceleration during the time period C.

The acceleration-lower limb muscle strength relation illustrated in FIG. 13 indicates a relation between an average up-down acceleration and a knee extension force during the certain time period that is indicated with arrow A (time period A) in FIG. 7 (a time period between the heel-strike and the foot-bottom landing-on). On the basis of the acceleration-lower limb muscle strength relation illustrated in FIG. 13, a knee extension force of the person can be measured by calculating an average up-down acceleration during the time period A.

An acceleration-lower limb muscle strength relation is obtained by applying a multiple regression analysis to a relation between three parameters and a dorsiflexion force. Three parameters are an average front-rear acceleration (Xa) during A period, a average front-rear acceleration (Xb) during B period and average up-down acceleration (Xc) during A period. Specifically, an acceleration-lower limb muscle strength relation is expressed by Formula A.
Dorsiflexion force (Y1)=A1Xa+B1Xb+C1Xc+D1 Formula A

Further, data is collected from plural test subjects, and the multiple regression analysis is applied to the data. On the basis of the data, more specific acceleration-lower limb muscle strength relation is expressed by Formula B.
Dorsiflexion force (Y1)=−0.53Xa−0.59Xb+0.1Xc+0.35 Formula B

A multiple correlation coefficient of this acceleration-lower limb muscle strength relation is approximately 0.6, which is relatively large. Thus, the parameters (Xa) (Xb) (Xc) are calculated by obtaining the acceleration-lower limb muscle strength relation calculated by Formulas A and B. In this way, the dorsiflexion force of the person can be measured more precisely.

An acceleration-lower limb muscle strength relation is obtained by applying a multiple regression analysis to a relation between three parameters and a knee extension force. Three parameters are an average front-rear acceleration (Xa) during period A, an average front-rear acceleration (Xb) during period B and average up-down acceleration (Xc) during period A. Specifically, an acceleration-lower limb muscle strength relation is expressed by Formula C.
Dorsiflexion force (Y2)=A2Xa+B2Xb+C2Xc+D2 Formula C

Further, data is collected from plural test subjects, and the multiple regression analysis is applied to the data. On the basis of the data, more specific acceleration-lower limb muscle strength relation is expressed by Formula D.
knee extension force (Y2)=−2.29Xa−3.34Xb−0.52Xc−0.5 Formula D

A multiple correlation coefficient of this acceleration-lower limb muscle strength relation is approximately 0.74, which is relatively large. Thus, the parameters (Xa) (Xb) (Xc) are calculated by obtaining the acceleration-lower limb muscle strength relation calculated by Formulas C and D. In this way, the dorsiflexion force of the person can be measured more precisely.

An actuation and a movement of the muscle level measuring device 100 in the second embodiment will be explained in detail. When the person having the muscle level measuring device 100 at his/her waist portion start walking, the accelerometer 10 of the muscle level measuring device 100 detects a front-rear acceleration, a right-left acceleration and an up-down acceleration at the waist portion. Changes in time of each acceleration is outputted to an A/D converter 22 as a waveform electric signal (acceleration signal). The acceleration signal is digitalized at the A/D converter 22, and the digital signal is temporally memorized in the RAM 28. The graph illustrated in FIG. 7 indicates examples of the changes with time of the acceleration signals (front-rear acceleration signal, right-left acceleration signal, up-down acceleration signal), which are detected at the accelerometer 10. As shown in the graph, each acceleration changes as time passed.

In the graph illustrated in FIG. 7, the front-rear acceleration is illustrated in a manner where its frontward direction is positive, the right-left acceleration is illustrated in a manner where its rightward direction is positive, and the up-down acceleration is illustrated in a manner where its upward direction is positive. The changes with time of each acceleration corresponds to a certain walking movement of the walking movement as shown in FIG. 7.

After the acceleration signals (front-rear acceleration, right-left acceleration, up-down acceleration) corresponding to one cycle of the walking movement are memorized in the RAM 28, a walking movement determining means extracts a timing and a time period (certain time period) at which the certain walking movement is performed from the changes with time of the acceleration signals. The walking movement determining means is comprised of the CPU 24 and the ROM 26.

Specifically, a peak of the acceleration signal is detected on the basis of a time derivative of the acceleration signal, and it is determined whether or not the certain walking movement starts or ends at the peak. More specifically, focusing on one of the front-rear acceleration, the up-down acceleration, or the right-left acceleration, it is also determined whether or not the certain walking movement starts or ends at a point where the acceleration changes from positive to negative, or from negative to positive. It is also determined whether or not the certain walking movement starts or ends at a timing where an acceleration becomes a predetermined percentage relative to the acceleration at the peak of the acceleration signal. An appropriate method may be selected from the above time period extracting methods at any time. A combination of the above time period extracting methods may also be used.

In the second embodiment, following determining methods are used in order to determine a certain walking movement shown in FIG. 7. First, a method for determining the heel-strike (the right heel-strike) illustrated in FIG. 7 will be explained as follows.

A significant negative peak (P1) of the front-rear acceleration is detected, and a minimum point (P2) existing immediately before the significant negative peak (P1) is detected. Secondly, it is determined whether or not a shift point (P3), at which the right-left acceleration changes from positive to negative, exists between the negative peak (P1) and the minimum point (P2). Thirdly, if the shift point (P3) exists between the negative peak (P1) and the minimum point (P2), it is determined that the right heel-strike is performed at the shift point (P3). On the other hand, if the shift point (P3) does not exist between the negative peak (P1) and the minimum point (P2), it is determined that the right heel-strike is performed at the minimum point (P2).

When a left heel-strike is determined, in the above process, it is determined whether or not a shift point (P4), at which the right-left acceleration changes from negative to positive, exists between the negative peak (P1) and the minimum point (P2), and if the shift point (P4) exists between the negative peak (P1) and the minimum point (P2), it is determined that the left heel-strike is performed at the shift point (P4). On the other hand, if the shift point (P4) does not exist between the negative peak (P1) and the minimum point (P2), it is determined that the light heel-strike is performed at the minimum point (P2).

According to the foot-bottom landing-on, it is determined that the foot-bottom landing-on is performed at a point where the up-down acceleration moves from positive to negative for the first time since the heel-strike is detected.

According to the toe-off, it is determined that the toe-off is performed at an earlier point where the up-down acceleration moves from negative to positive for the first time since the foot-bottom landing-on is performed, and a point where the up-down acceleration becomes maximum for the first time since the foot-bottom landing-on is performed.

The CPU 24 calculates an average acceleration during the certain time period in which the certain walking movement is performed on the basis of the obtained point at which the certain walking movement is performed as mentioned above. Specifically, an average front-rear acceleration during A period can be obtained as an estimated indicator by calculating an average acceleration of the front-rear acceleration on the basis of a front-rear acceleration signal between a point at which it is determined the heel-strike is performed and a point at which it is determined the foot-bottom landing-on is performed. An average front-rear acceleration and an average up-down acceleration during other periods can also be obtained in the same manner as the above. Such calculated average acceleration is used as an estimated indicator, and a lower limb muscle strength is measured using the estimated indicator referring to the acceleration-lower limb muscle strength relation.

Specifically, the lower limb muscle strength is measured as follows. The CPU 24 applies the calculated average acceleration (the front-rear acceleration or the up-down acceleration during the certain time period corresponding to the acceleration-lower limb muscle strength relation) to the acceleration-lower limb muscle strength relations shown in FIGS. 8 through 13, so that the lower limb muscle strength is derived. The derived lower limb muscle strength or the measured past information that has been memorized in the memory portion 50 may be displayed on the display portion 40 together with person and date information.

It is possible to derive the dorsiflexion force and the knee extension force by selecting two or more acceleration-lower limb muscle strength relations, by which each of the dorsiflexion force and the knee extension force can be derived, from the acceleration-lower limb muscle strength relations illustrated in FIGS. 8 through 13 or the acceleration-lower limb muscle strength relations obtained on the basis of the above mentioned results of the multiple regression analysis.

The derived dorsiflexion force and knee extension force may be temporally memorized in RAM 28 and further memorized in the memory portion 50 automatically or by a person's operation. The derived dorsiflexion force and knee extension force may be memorized in the memory portion 50 together with person's information, date information and information related to referred acceleration-lower limb muscle strength relation.

A walking age of the person (referring to a walking ability of the person) at the present time can be calculated on the basis of the level of the derived lower limb muscle strength. Specifically, a relation between a level of a lower limb muscle strength and a walking age is memorized in advance in the ROM 26, and a walking age is calculated by applying the calculated lower limb muscle strength to the memorized relation between a level of a lower limb muscle strength and a walking age. As the lower limb muscle strength used for calculating the walking age, at least one of the dorsiflexion force and the knee extension force is used. The calculated walking age is temporally memorized in the RAM 28. The calculated walking age may be memorized in the memory portion 50 automatically or by a person's operation.

After the level of a dorsiflexion force is obtained at the CPU 24, the obtained result may be displayed on the display portion 40. In this case, the person can select the items to display from a level of a dorsiflexion force; a level of a dorsiflexion force and a walking age; and the estimated result of the selected item may be displayed on the display. All the estimated results may be automatically displayed on the display.

Further, on the basis of the estimated lower limb muscle strength or the walking age, a guidance of exercises to improve the lower limb muscle strength can be displayed on the display portion so that the person can follow the guidance.

Thus, the muscle level measuring device 100 according to the second embodiment, can measure a lower limb muscle strength of a person without using a major machine. Further, according to the second embodiment, a muscle level can be detected by the muscle level measuring device 100, which is attached to the waist portion of the person; as a result, burden on the person can be reduced. Further, the muscle level measuring device 100 according to the second embodiment, on the basis of only the walking movement, levels of a lower limb muscle strength of both a dorsiflexion force and a knee extension force can be measured. Thus, different lower limb muscle strength can be measured by one measuring method. Further, when the muscle level measuring device 100 according to the second embodiment is used in order to improve the decline of the lower limb, because specific information about lower limb muscle strength, such as a dorsiflexion force and a knee extension force, can be obtained, the person can know which specific part in his/her lower limb has declined. Furthermore, it can be possible that the person know without difficulty which specific means is needed for the person to improve the decline on his/her lower limb.

According to the walking analyzer and the walking analyzing method of the present invention, because there is a correlative relation between changes with time of an acceleration at the waist portion during a certain time period and a walking ability, the walking analyzer or the walking analyzing method estimates a walking ability only by detecting an acceleration at the waist portion.

Further, because the certain time period in which a certain walking movement is performed is extracted on the basis of changes of the time of each acceleration at the waist portion outputted on the basis of the waking movement, and a walking ability is estimated with an estimated indicators calculated on the basis of the changes with time of each acceleration during the certain time period, even when a timing at which the waking movement is performed varies on each person, the certain time period is accurately extracted, as a result, a walking ability may be generally estimated.

Furthermore, the time period extracting means extracts two points at which a certain walking movement is performed, and sets a time period between the two points to a certain time period. Thus, a certain time period in which a certain walking movement is performed is easily extracted. Further, if this apparatus according to the present invention is used to give a rehabilitation training for a patient, because a walking speed and a walking stride is estimated on each leg, an effect of the training or a portion at which a training is needed is clearly defined, as a result, a treatment on the patient is operated effectively.

### THIRD EMBODIMENT

A third embodiment of the present invention will be explained. In the third embodiment, a walking speed is estimated as walking ability. As a result of inventor's intensive researches by the inventors of the present intention, it is found that there is a correlative relation between a certain estimated indicator and a level of a walking speed, a certain estimated indicator being calculated on the basis of changes with time of an acceleration at waist portion during a certain time period in which a certain walking movement has performed while the person is walking.

In other word, a walking analyzer 100 related to the third embodiment includes an acceleration measuring means (accelerometer 10) serving as an acceleration measuring step, a time period extracting means (ROM 26, CPU 24) serving as a time period extracting step, an estimated indicator calculating means (ROM 26, CPU 24) serving as an estimated indicator calculating step and a walking ability estimating means (ROM 26, CPU 24) serving as a walking speed estimating step. Specifically, the acceleration measuring means (accelerometer 10) detects each acceleration in an up-down direction, a front-rear direction and a right-left direction at waist portion while walking.

The time period extracting means (ROM 26, CPU 24) extracts, on the basis of changes with time of at least one of the accelerations, a certain time period in which a certain walking movement related to a level of a walking speed, has performed. The estimated indicator calculating means (ROM 26, CPU 24) calculates, on the basis of changes with time of at least one of the accelerations, an estimated indicator that relates to a level of a walking speed. The walking ability estimating means (ROM 26, CPU 24) estimates a walking speed using the estimated indicator calculated by the estimated indicator calculating means and a predetermined relation between an estimated indicator and a level of the walking speed. The walking ability estimating means includes a memory means (memory device, ROM 26) in which the predetermined relation between the estimated indicator and the level of the walking speed is memorized.

A relation (relational formula) between the estimated indicator and a walking speed, memorized in the ROM 26 according to the third embodiment, will be explained in detail.

(Estimated Indicator V1)

An advanced speed, in other words a walking speed, has been calculated by integrating a front-rear acceleration, however, it has been considered that such result generally has an integral error, and such error affects on an estimation accuracy. The walking movement mainly includes an acceleration movement and a deceleration movement, and these movements are repeated. When a ratio of a time period, during which an acceleration movement is performed (hereinbelow referred to as an acceleration time), is larger than a time period, during which a deceleration movement is performed (hereinbelow referred to as a deceleration time), it is considered that the walking speed is relatively high. Thus, it is considered that a ratio of the deceleration time within the time period of one step is used as an estimated indicator.

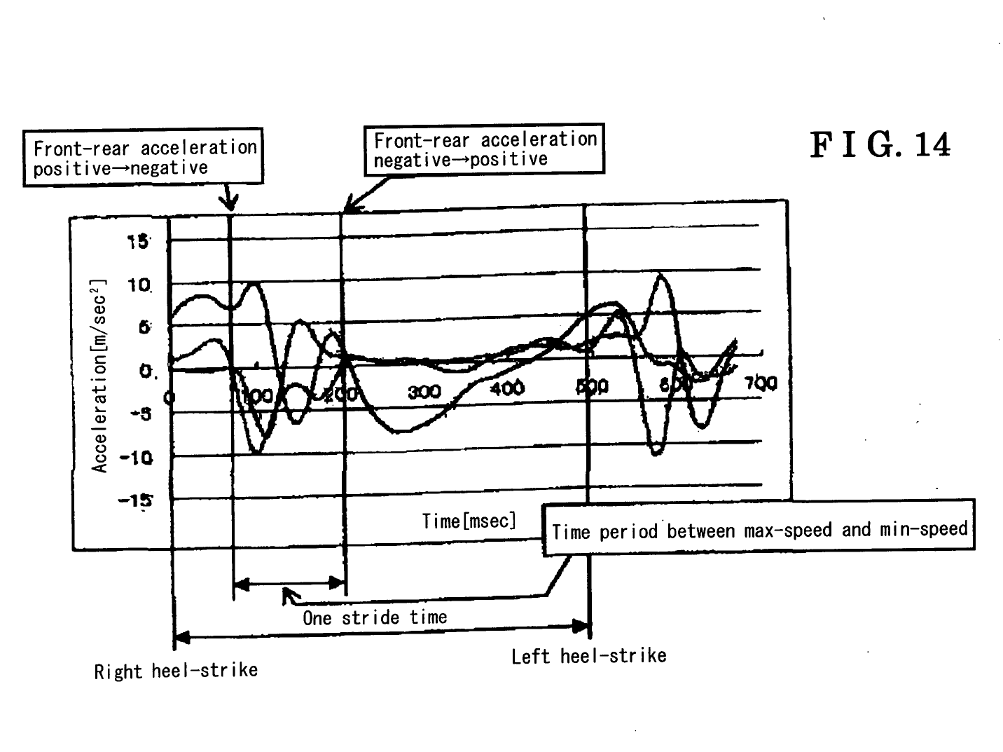

A graph illustrated in FIG. 14, which is similar to the graph illustrated in FIG. 7, is an explanation diagram indicating a time period of one step and a deceleration time.

In this graph, the deceleration time corresponds to a time period between a point at which the front-rear direction is at its maximum speed (hereinbelow referred to as a maximum speed position) and a point at which the front-rear direction is at its minimum speed (hereinbelow referred to as a minimum speed position). An estimated indicator V1 is calculated by the following formula.
Estimated indicator V1=Time period between a front-rear maximum speed position and a front-rear minimum speed position/Time for one step.

Because the acceleration is obtained by differentiating the speed, a point at which a front-rear speed is at its maximum is corresponds to a point at which the front-rear acceleration changes from positive to negative. On the other hand, a point at which the front-rear speed is at its minimum is corresponds to a point at which the front-rear acceleration changes from negative to positive. Thus, “Time period between a front-rear maximum speed position and a front-rear minimum speed position” corresponds is obtained by the following formula.
“Time at which the front-rear acceleration becomes negative to positive”−“Time at which the front-rear acceleration becomes positive to negative”

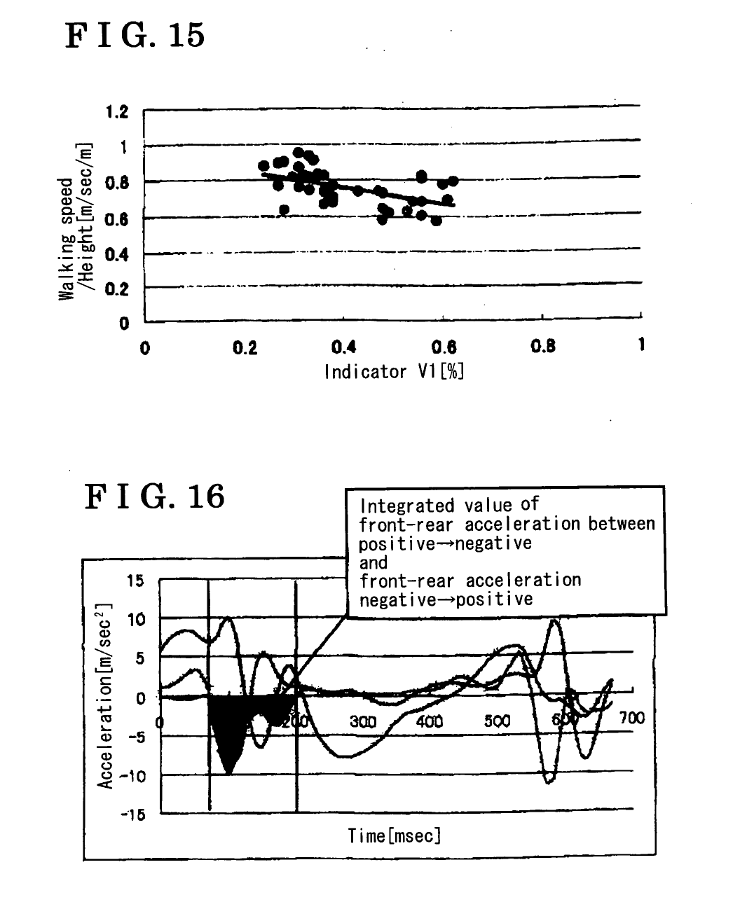

The graph illustrated in FIG. 15 is created on the basis of deceleration times calculated on the basis of the explanation diagram illustrated in FIG. 14. In the graph illustrated in FIG. 15, the x-axis indicates an estimated indicator V1 (deceleration time/time of one step) (%), and the y-axis indicates a walking speed/body height (m/sec/m). An actual walking speed is used as the walking speed in y-axis, and the actual walking speed is obtained by use of a three-dimensional motion analyzing system.

In order to standardize by reducing the individual difference, the walking speed is divided by the body height at the y-axis. As shown in FIG. 15, the smaller the deceleration time in the time of one step becomes, the larger the value obtained by dividing the walking speed by the body height becomes. As shown in FIG. 15, there is a negative correlation between the indicator V1 and the value that is obtained by dividing the walking speed by the body height.

(Estimated Indicator V2)

It is considered that, after a large positive acceleration occurs, a large negative acceleration occurs. When the walking speed is high, it is considered that changes of the acceleration is significant. Thus, the negative front-rear acceleration indicating the deceleration during the time period of one step is supposed to reflect a walking speed.

When the changes of the acceleration is large, consumption energy becomes large. Because there is a relation between the estimated indicator V1 and the walking speed as mentioned above, it is determined that, when the walking speed is high, the time consumed for the acceleration movement becomes long during the time of one step. In other words, when a large deceleration (negative acceleration) occurs, an acceleration time is supposed to be long. Thus, it is considered that a person walks so as to reduce the consumption energy, on the basis of an assumption that a normal walk requires a minimum consumption energy.
Estimated indicator V2=Integral value between a point at which the front-rear acceleration changes from positive to negative and a point at which the front-rear acceleration changes from positive to negative/Integral time period.

“Integral value between a point at which the front-rear acceleration changes from positive to negative and a point at which the front-rear acceleration changes from positive to negative” is obtained by time-integrating a front-rear acceleration during a time period from “the maximum speed position to the minimum speed position”, which is described in the explanation of the estimated indicator V1. The estimated indicator V2 is a value that is obtained by dividing the above integrated value by the integral time period. The estimated indicator V2 indicates an average deceleration rate while the deceleration movement is performed.

FIG. 16, which is similar to FIG. 7 illustrates an explanation diagram indicating the integrated value of the front-rear acceleration during a period from a point at which the front-rear acceleration changes from positive to negative to a point at which the front-rear acceleration changes from negative to positive.

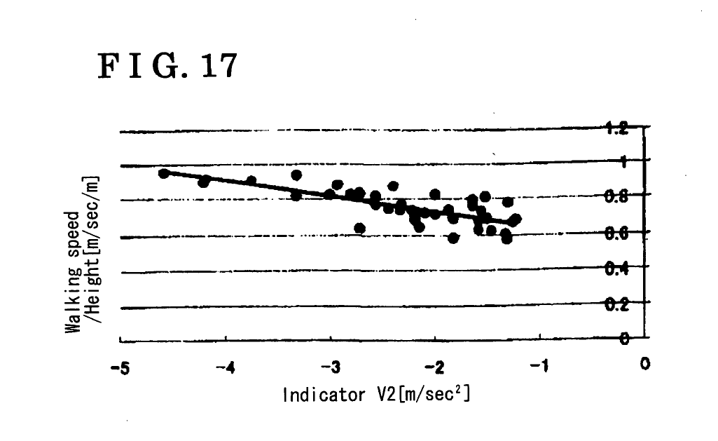

Further, FIG. 17 illustrates a graph in which the x-axis indicates an estimated indicator V2 (m/sec/sec), and the y-axis indicates a walking speed/body height (m/sec/m). As shown in FIG. 17, there is a negative relation between the estimated indicator V2 and the walking speed/body height.

(Estimated Indicator V3)

A gravity point of the person's body reciprocates vertically while he/she is walking. The position of the gravity point of the person's body reaches lowest when the heel-strike is performed, and reaches highest when the person's body is approximately upright (mid-stance). After the mid-stance, the leg is lifted forward, and the gravity point of the person moves downward, and when the heel-strike is performed, the gravity point of the person reaches lowest.

Thus, it is considered that a walking speed is reflected on each of an upward acceleration generated when the gravity point of the person moves upward, an upward decrease acceleration generated when the upward moving speed is reduced, and an downward acceleration generated when the gravity point of the person moves downward.

Because it is considered that the upward acceleration includes vibrations caused by an impact generated when the heel-strike is performed, the upward decrease acceleration and the downward acceleration, which is little affected by the vibrations caused by an external force, are focused on in this embodiment. Because the toe-off is followed by the mid-stance, it is considered that the negative acceleration of the up-down acceleration after the toe-off indicates a downward acceleration of the gravity point of the body when the leg is lifted forward.

It is also considered that the positive up-down acceleration detected immediately before the heel-strike is an acceleration for reducing the downward speed in order to absorb an impact generated when the heel-strike is performed. Because of this impact absorption, an impact on the muscles when the heel-strike is performed can be reduced, and this can affirm the assumption of reducing the consumption energy. Thus, an absolute values of the both integrated values, which are considered reflecting on the walking speed, are added in order to obtain the estimated indicator V3.
Estimated indicator V3=|Speed reduction amount of the upward speed/time period|+|Speed reduction amount of the downward speed/Speed period|.

“Speed reduction amount of the upward speed” indicates a time-integrated value of the up-down acceleration during a time period from a point at which the toe-off is performed to a point at which the up-down acceleration changes from negative to positive.

“|Speed reduction amount of the upward speed/time period|” means an absolute value of a reduction rate of the up-down direction average during the certain time period. “Speed reduction amount of the downward speed” indicates a time-integrated value of the up-down acceleration during a certain time period from a point at which the up-down acceleration changes from negative to positive to a point at which the heel-strike is performed. “|Speed reduction amount of the downward speed/time period|” means an absolute value of the up-down direction average acceleration during the certain time period.

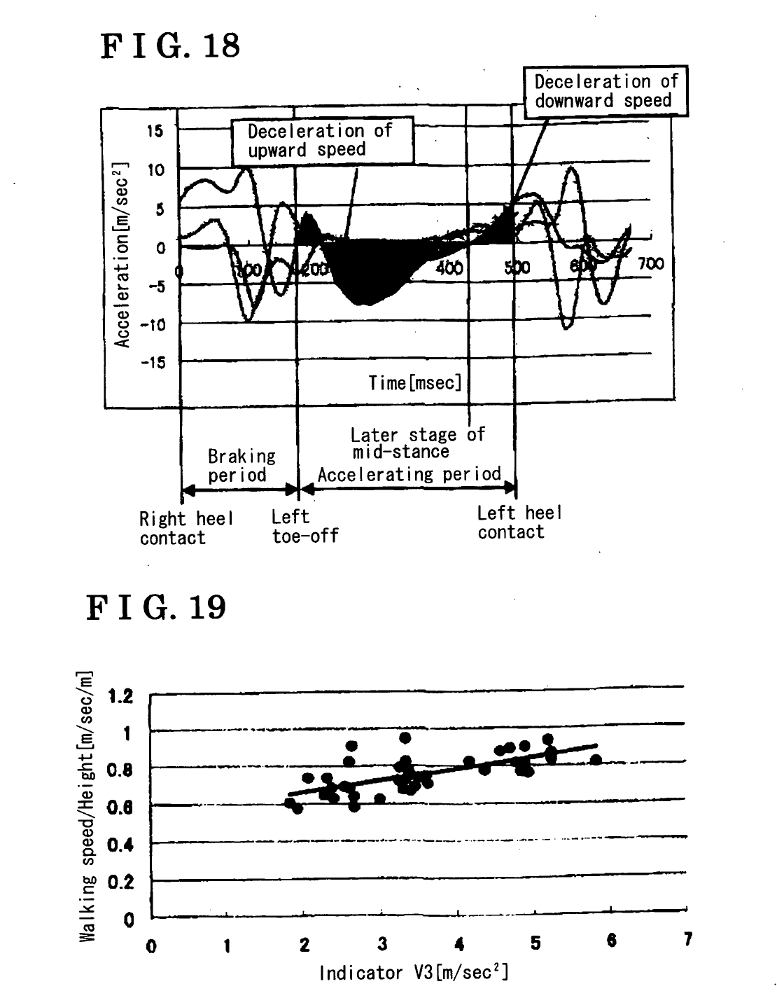

FIG. 18 illustrates an explanation diagram, which is similar to the graph illustrated in FIG. 7, indicating each acceleration during a breaking period, an accelerating period, and a later stage of the mid-stance. The speed reduction amount of the upward speed and the speed reduction amount of the downward speed are indicated with arrows. FIG. 19 illustrates a graph in which the x-axis indicates an estimated indicator V3 (m/sec/sec), and the y-axis indicates a walking speed/body height (m/sec/m). As shown in FIG. 19, there is a relation between the estimated indicator V3 and the walking speed/body height.

(Estimated Indicator V4)
Estimated indicator V4=(Integrating a front-rear acceleration from the right (left) heel-strike to the left (right) heel-strike, and calculating a difference between the maximum speed and the minimum speed)/(Time between front-rear maximum speed position and the front-rear minimum speed position/time of one step).

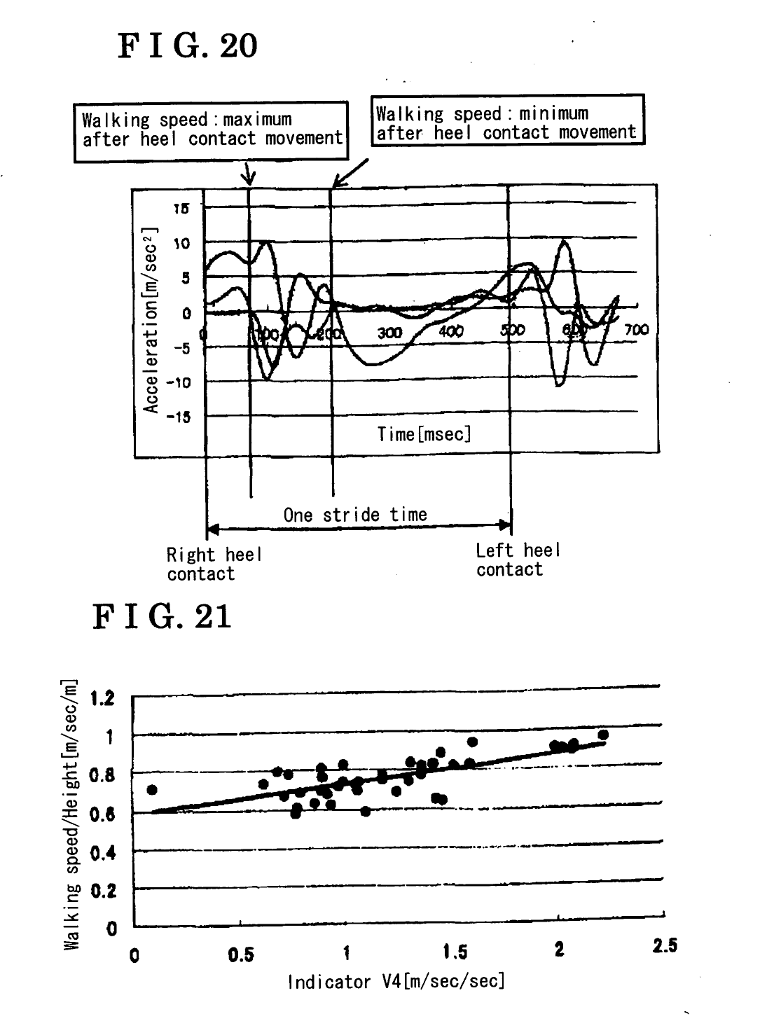

FIG. 20 illustrates a diagram explaining a point at which the speed is at its maximum, and a point at which the speed is at its minimum during the time of one step. FIG. 21 illustrates a graph in which the x-axis indicates an estimated indicator V4 (m/sec/sec), and the y-axis indicates a walking speed/body height (m/sec/m). As shown in FIG. 21, there is a positive relation between the estimated indicator V4 and the walking speed/body height.

(Estimated Indicator V5)

The front-rear acceleration during a period from the right toe-off, which performed in an early stage of the accelerating period, to the later stage of the right mid-stance (a point at which the up-down acceleration changes from negative to positive after the toe-off) is integrated, and the front-rear speed when the later stage of the right mid-stance is set an estimated indicator V5 of the walking speed.

A front-rear speed during the later stage of the left mid-stance can be used in the same manner as the above method.
Estimated indicator V5=Integrated value of the front-rear acceleration from the right (left) toe off to the later stage of the right (left) mid-stance.

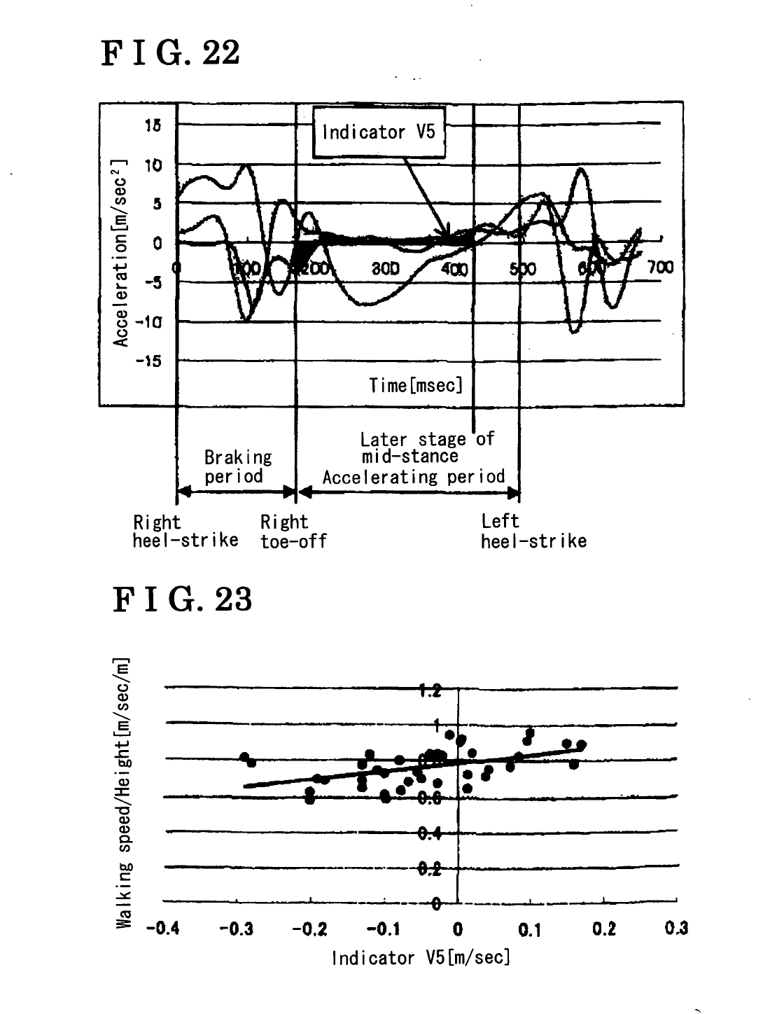

In the same manner as the graph illustrated in FIG. 7, FIG. 22 illustrates an explanation diagram indicating the breaking period, the accelerating period, and the later stage of the mid-stance. The shaded area indicates a value of an estimated indicator V5. The estimated indicator V5 is calculated by use of the explanation diagram illustrated in FIG. 22, and a graph illustrated in FIG. 23 is based on the estimated indicator V5. In the graph of the FIG. 23, the x-axis indicates an estimated indicator V5 (m/sec), and the y-axis indicates a walking speed/body height (m/sec/m). There is a positive relation between the estimated indicator V5 and the walking speed/body height.

(Estimated Indicator V6)

An estimated indicator V6 is calculated as follows. A speed is calculated by integrating an up-down acceleration during a period from the early stage of the mid-stance (a point at which the up-down acceleration changes from positive to negative for the first time since the toe-off is performed) to the later stage of the mid-stance. Then, another speed is calculated by integrating the up-down acceleration during a period from the later stage of the mid-stance to the heel-strike of the other leg. Finally, these speeds are summed so as to be the estimated indicator V6.
Estimated indicator V6=|Integrated value of an up-down acceleration from the early stage of the mid-stance of one leg to the later stage of the mid-stance of the one leg|+|Integrated value of an up-down acceleration from the later stage of the mid-stance of one leg to immediately before the heel-strike of the other leg|.

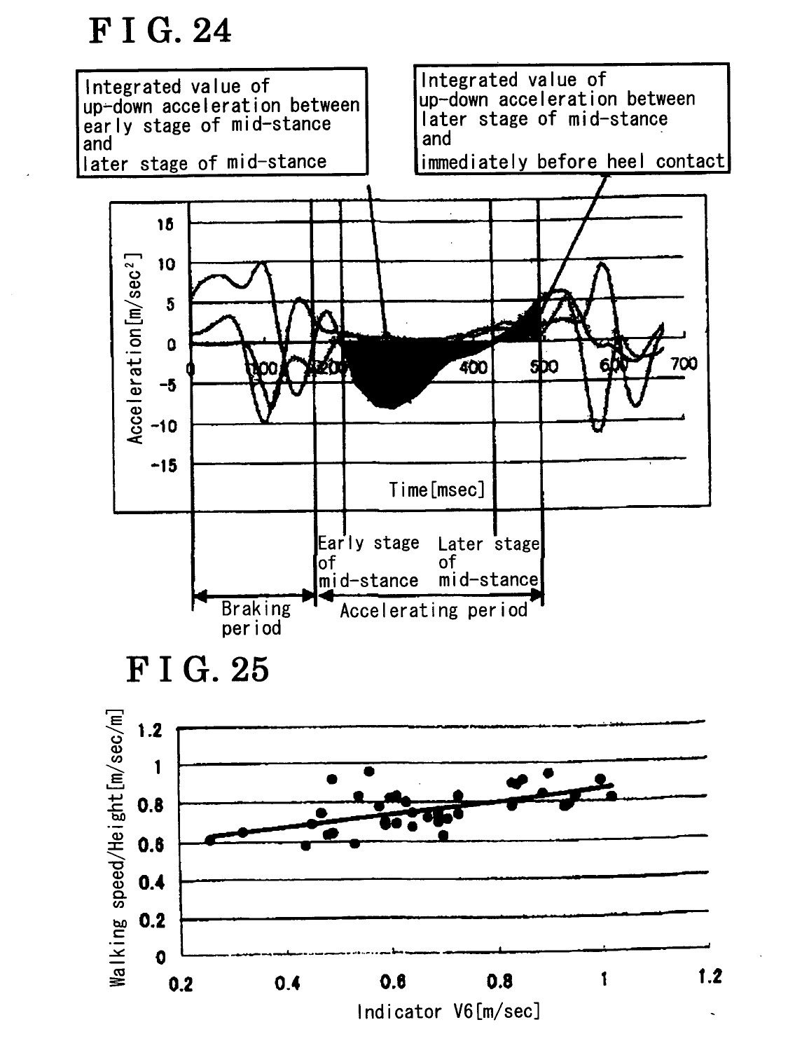

FIG. 24 illustrates an explanation diagram using a graph, which is similar to the graph illustrated in FIG. 7, indicating a breaking period, an accelerating period, an early stage of the mid-stance and a later stage of the mid-stance.

A graph illustrated in FIG. 25 indicates an estimated indicator V6 calculated by use of the explanation diagram shown in FIG. 24. In FIG. 25, the x-axis indicates an estimated indicator V6 (m/sec), and the y-axis indicates walking speed/body height (m/sec/m). As shown in FIG. 25, there is a positive correlation between the estimated indicator V6 and the walking speed/body height.

(Estimated Indicator V7)
Estimated indicator V7=Estimated indicator V6/Estimated indicator V1.

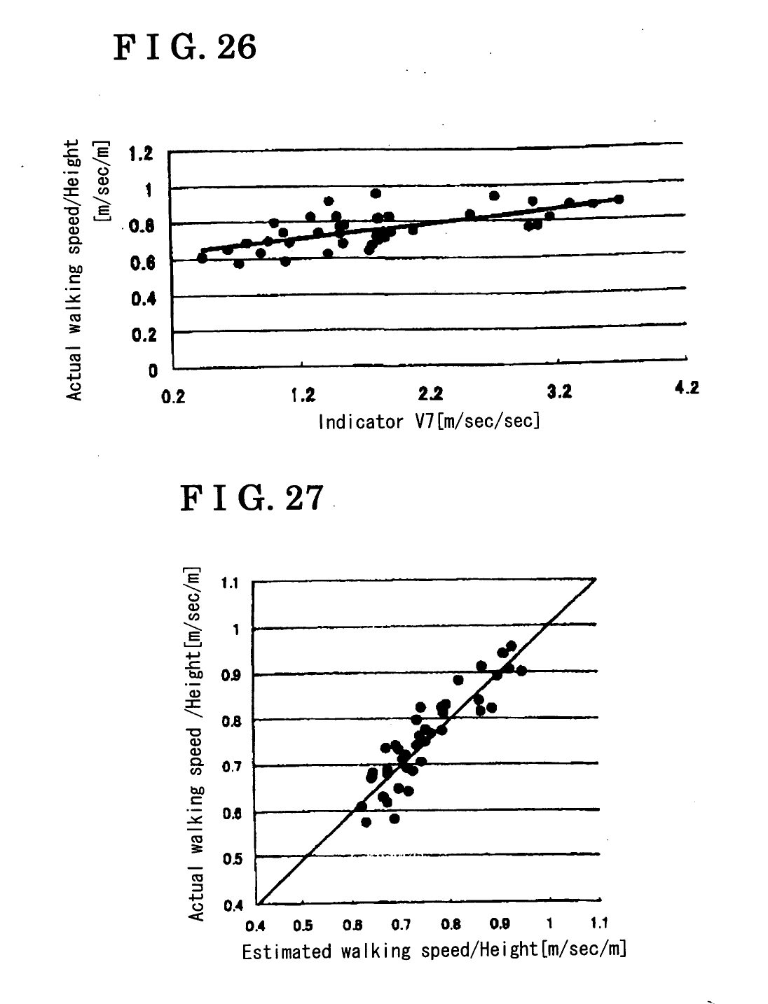

A graph illustrated in FIG. 26 indicates a calculated estimated indicator V7. In FIG. 26, the x-axis indicates an estimated indicator V7 (m/sec/sec), and the y-axis indicates walking speed/body height (m/sec/m). As shown in FIG. 26, there is a positive correlation relation between the estimated indicator V7 and the walking speed/body height.
(Walking speed estimation formula=Relational formulas between the estimated indicators V and walking speeds)

A relational formula for estimating the walking speed on the basis of the above calculated the estimated indicators V1 through V7 will be explain. By use of one of the estimated indicators V1 through V7 together with a coefficient, a walking speed can be obtained. In this case, a relational formula is indicated by a straight line in each of FIGS. 15, 17, 19, 21, 23, 25 and 26. However, in order to increase the accuracy, the relational formula can be obtained by use of a multiple regression analysis using plural estimated indicators. An example of the estimated formula using the estimated indicators V1 through V3 is as follows.
Walking speed=0.249* estimated indicator V1−0.091* estimated indicator V2+0.049* estimated indicator V3+0.269.

An estimated walking speed is calculated by substituting the estimated indicators V1 through V3 calculated on the basis of the measured data into the above relational formula to see a correlation relation between the estimated walking speed and an actual walking speed. FIG. 27 illustrates a graph in which the x-axis indicates an estimated walking speed/body height (m/sec/m), and the y-axis indicates an actual walking speed/body height (m/sec/m). As shown in FIG. 27, the estimated walking speed/body height (m/sec/m) and the actual walking speed/body height (m/sec/m) are highly correlated. The actual walking speed is same as the walking speed that is used in FIG. 15 or 16. An example of the estimated formula using the estimated indicators V4 through V7 is as follows.
Walking speed=0.18* estimated indicator V4+0.56* estimated indicator V5+0.69* estimated indicator V6−0.15* estimated indicator V7+0.38.

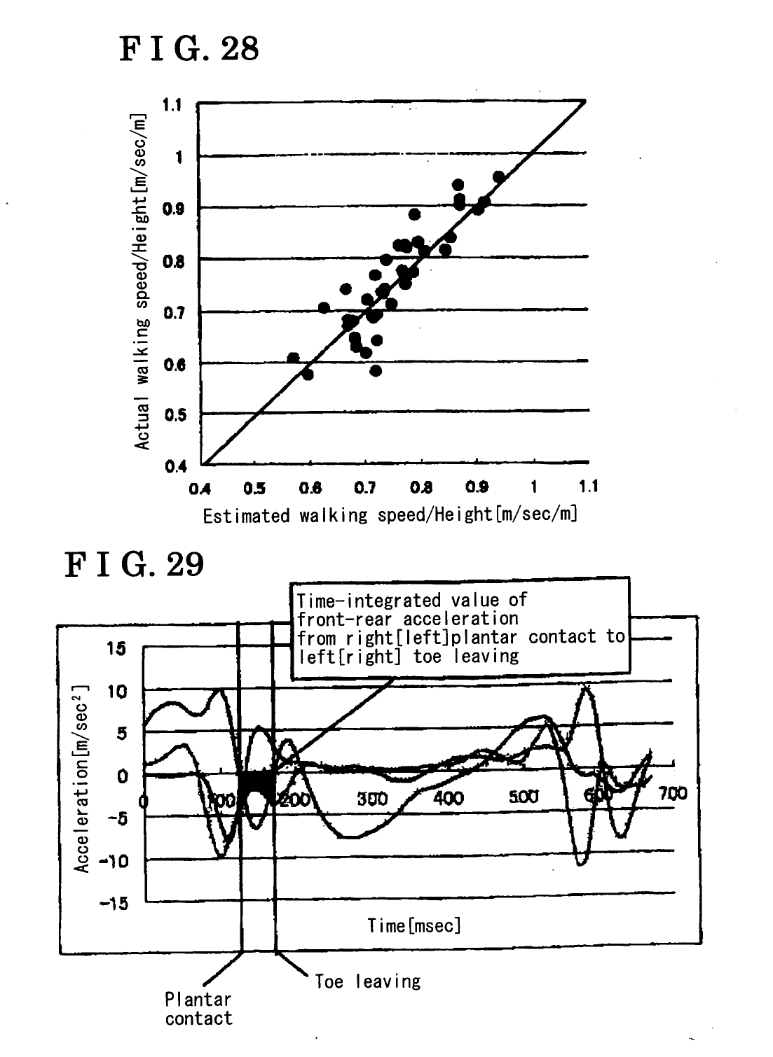

An estimated walking speed is calculated by substituting the estimated indicators V4 through V7 calculated on the basis of the measured data into the above relational formula to see a correlation relation between the estimated walking speed and an actual walking speed. FIG. 28 illustrates a graph in which the x-axis indicates an estimated walking speed/body height (m/sec/m), and the y-axis indicates an actual walking speed/body height (m/sec/m).

As shown in FIG. 28, the estimated walking speed/body height (m/sec/m) and the actual walking speed/body height (m/sec/m) are highly correlated. The actual walking speed is same as the waling speed that is used in FIG. 15 or 16.

### FOURTH EMBODIMENT

A fourth embodiment of the present invention will be explained. In the fourth embodiment, a walking stride is estimated as a walking ability. As a result of inventor's intensive researches by the inventors of the present invention, it is found that there is a correlative relation between a certain estimated indicator and a level of a walking stride, a certain estimated indicator being calculated on the basis of changes with time of an acceleration at waist portion during a certain time period in which a certain walking movement has performed while the person is walking. In other word, a walking analyzer 100 related to the first embodiment includes an acceleration measuring means (accelerometer 10) serving as an acceleration measuring step, a time period extracting means (ROM 26, CPU 24) serving as a time period extracting step, an estimated indicator calculating means (ROM 26, CPU 24) serving as an estimated indicator calculating step and a walking ability estimating means (ROM 26, CPU 24) serving as a walking stride estimating step.

Specifically, the acceleration measuring means (accelerometer 10) detects each acceleration in an up-down direction, a front-rear direction and a right-left direction at waist portion while the person is walking. The time period extracting means (ROM 26, CPU 24) extracts, on the basis of changes with time of at least one of the accelerations, a certain time period in which a certain walking movement, which relates to a level of a walking stride, has performed. The estimated indicator calculating means (ROM 26, CPU 24) calculates, on the basis of changes with time of at least one of the accelerations, an estimated indicator that relates to a level of a level of a dorsiflexion force. The walking ability estimating means (ROM 26, CPU 24) estimates a walking stride using the estimated indicator calculated by the estimated indicator calculating means and a predetermined relation between an estimated indicator and a level of the walking stride. The walking ability estimating means includes a memory means (memory device, ROM 26) in which the predetermined relation between the estimated indicator and the level of the walking stride is memorized.

A relation (relational formula) between the estimated indicator and a walking stride, memorized in ROM 26, will be explained below. In the same manner as the third embodiment, in the relational formula between the estimated indicator and the walking stride, it is initially assumed that a normal walking is performed with a minimum energy.

(Estimated Indicator S1)

Considering that a steady walking is performed in a manner a walking speed has not been changed within a period between a point at which the heel-strike is performed and point at which another heel-strike is performed, there is a positive correlation relation between the walking speed and the walking stride. Specifically, when the walking speed is higher, the walking stride is large, and when the walking speed is low, the walking stride is small. When the walking speed is high, a large acceleration occurs, on the contrary, a large decrease acceleration occurs. Thus, it is considered that the walking stride is reflected in an amount of the decrease acceleration within a time period of one step.

Because there is a possibility that; the walking speed is high even when the walking stride becomes small, and the walking speed is low even when the walking stride is large; according to the amount of the decrease acceleration during a time period of one step is performed, it is considered that a level of a speed reduction amount during a time period between the point at which the foot-bottom landing-on is performed and a point at which the toe-off is performed, which is immediately before the lift forward movement, is a speed reduction amount in which a walking stride is much reflected.

Specifically, after the walking speed is decreased, the person moves his/her body forward by use of a triceps surae muscle in order to recover the speed to an initial speed. At this point, the person obviously needs to move his/her legs forward in order to move his/her body forward. Thus, it is considered that, the larger the speed reduction amount becomes, the larger a level of the acceleration needs to be, so that the person is supposed to widely move his/her leg forward. Thus, an estimated indicator S1 is calculated as follows. A front-rear acceleration during a period from a point at which the foot-bottom landing-on is performed and a point at which the toe-off is performed is integrated, and the integrated value is divided by a time period.
Estimated indicator S1=“Time-integrated value of a front-rear acceleration during a period between a left (right) toe-off and a front-rear acceleration”/“Time period”.

“Time-integrated value of a front-rear acceleration during a period between a left (right) toe-off and a front-rear acceleration/time period” indicates an average deceleration.

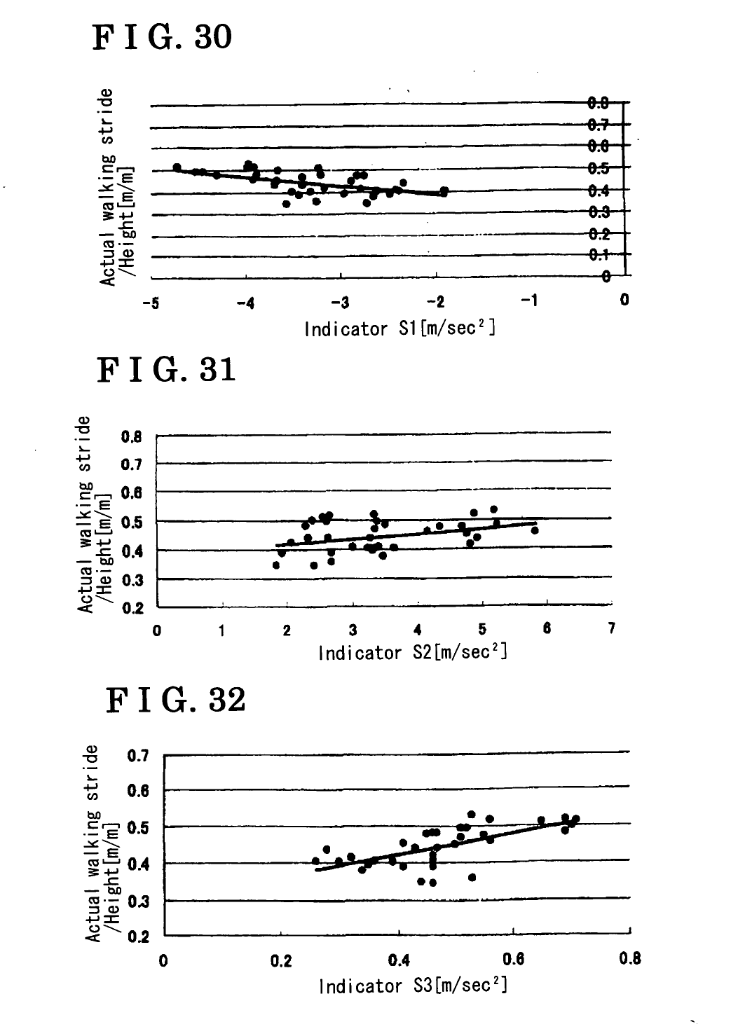

An explanation diagram indicating the foot-bottom landing-on and the toe-off is illustrated in FIG. 29 in the same manner as the graph illustrated in FIG. 7. An estimated indicator S1 is calculated on the basis of the explanation diagram illustrated in FIG. 29, and a graph indicating the estimated indicator S1 is illustrated in FIG. 30. In the graph illustrated in FIG. 30, the x-axis indicates an estimated indicator S1 (m/sec/sec), and a y-axis indicates a walking stride/body height (m/m). In this case the walking stride is actually measured by use of a three-dimensional motion analyzing system and a device for measuring a floor reaction force. As shown in FIG. 30, there is a negative correlation relation between the estimated indicator S1 and the walking stride/body height.

(Estimated Indicator S2)

A gravity point of the person's body while the person is walking repeats reciprocating movement in an up-down direction. While the heel-strike is performed, the point of the gravity point of the person's body reaches the lowest position, and while the person's body is an approximately upright position (mid-stance), the point of the gravity point of the person's body reaches the highest position.

Specifically, because the leg is moved forward after the mid-stance, the gravity point of the person's body moves downward, and when the heel-strike is performed, the gravity point reaches a lowest point.

Because there is a positive correlation relation between the walking speed and the walking stride, when the walking stride is large, a time period between the heel-strike and the mid-stance is short. Further, an upward acceleration generated while the gravity point moves upward becomes large, and the upward decrease acceleration generated while the upward moving speed is reduced becomes large.

Furthermore, the wider the leg is moved forward, the larger the level of the downward acceleration generated while the gravity point moves downward becomes. Thus, it is considered that the walking stride is reflected in the upward acceleration, the upward decrease acceleration and the downward acceleration.

Because it is considered that the upward acceleration includes vibrations caused by an impact generated while the heel-strike is performed, the upward decrease acceleration and the downward acceleration, which are little affected by vibration generated by the external force, are focused on in this embodiment.

Because the mid-stance is performed after the toe-off, it is considered that the negative acceleration occurs in displacement of the up-down acceleration generated after the toe-off indicates an up-down decrease acceleration occurred immediately before the mid-stance and a downward acceleration of the gravity point of the person's body occurred when the leg is moved forward. It is also considered that the positive up-down acceleration generated immediately before the heel-strike indicates an acceleration for decreasing the downward speed in order to absorb the impact occurred while the heel-strike is performed.

An estimated indicator S2 is calculated by adding the absolute values of both integrated values, which reflect the walking stride. The estimated indicator S2 is identical to the estimated indicator V3.

Estimated indicator S2=|Speed reduction amount of upward speed/time period|+|Speed reduction amount of downward speed/speed period| “Speed reduction amount of upward speed” indicates a time-integrated value of an up-down acceleration during a time period between a point at which the toe-off is performed and a point at which the up-down acceleration changes from negative to positive. Thus, “|Speed reduction amount of upward speed/time period|” indicates an absolutes value of an up-down direction average deceleration during the time period between a point at which the toe-off is performed and a point at which the up-down acceleration changes from negative to positive. “Speed reduction amount of downward speed” indicates a time-integrated value of an up-down acceleration during a time period between a point at which the up-down acceleration changes from negative to positive and a point at which the heel-strike is performed. Thus, “|Speed reduction amount of downward speed/time period|” indicates an absolutes value of a up-down direction average deceleration during the above period.

An explanation diagram indicating a breaking period, an accelerating period, a later stage of the mid-stance is illustrated in FIG. 18 in the same manner as the graph illustrated in FIG. 7. A speed reduction amount of an upward speed and a speed reduction amount of a downward speed are indicated by arrows. In a graph illustrated in FIG. 31, the x-axis indicates an estimated indicator S2 (m/sec/sec), and the y-axis indicates walking stride/body height (m/m). There is a positive correlation relation between the estimated indicator S2 and the walking stride/body height.

(Estimated Indicator S3)

During a time period of one step (from a point at which the heel-strike is performed by one leg to a point at which the heel-strike is performed by another leg), a deceleration movement and an acceleration movement are performed. Specifically the deceleration movement is performed during a period between a point at which the heel-strike is performed and a point at which the another toe-off is performed (two legs mid-stance), and the acceleration movement is performed so as to move forward during a period between a point at which the deceleration movement is performed after the another toe-off is performed. The forward acceleration movement is performed in a manner where a leg that is lifted up is moved forward, at the same time a forward acceleration is generated by use of the triceps surae muscle of the person's body.

When the walking stride is small, the leg is narrowly moved forward. Further, during one leg mid-stance, because the person's body needs to be keep stably by one leg, an extra burden is imposed on the lower limb muscle. Thus, when the leg is narrowly moved forward, the time period in which the leg is moved forward is supposed to be short.

On the basis of the above consideration, because it is hard to generate a large amount of an acceleration during a short time period, when the stride is small, in other words, the swing phase is short, the amount of the acceleration generated during the one leg mid-stance is supposed to be reduced. It is considered that, in order to cover this reduction in the acceleration, the speed reduction amount while the two legs mid-stance is reduced.

Thus, it is considered that variation on the speed while the person is walking is reduced. Thus, a front-rear acceleration from the point at which the heel-strike is performed and the point at which another heel-strike is performed is integrated, and the calculated value is converted into a speed, and a difference between a maximum speed and a minimum steed is set to an estimated indicator S3.

Estimated indicator S3=Difference between a maximum speed and a minimum speed during a period between a right (left) heel-strike and a left (right) heel-strike.

“Difference between a maximum speed and a minimum speed during a period between a right (left) heel-strike and a left (right) heel-strike” is identical to “integrating a front-rear acceleration from the right (left) heel-strike to the left (right) heel-strike, and calculating a difference between the maximum speed and the minimum speed” described in the explanation of the estimated indicator V4.

In other words, “Difference between a maximum speed and a minimum speed during a period between a right (left) heel-strike and a left (right) heel-strike” is calculated by subtracting the minimum speed from the maximum speed, specifically by subtracting a time-integrated value of the front-rear acceleration during a time period between a point at which the heel-strike is performed and a point at which the front-rear acceleration is changed from negative to positive from a time-integrated value (maximum speed) of the front-rear acceleration during a time period between a point at which the heel-strike is performed and a point at which the front-rear acceleration is changed from positive to negative.

FIG. 32 illustrates a graph in which the x-axis indicates an estimated indicator S3 (m/sec/sec), and the y-axis indicates a walking stride/body height (m/m). There is a positive correlative relation between the estimated indicator S3 and the walking stride/body height.

(Estimated Indicator S4)

When the walking stride is small, the leg is generally narrowly moved forward. Further, during swing phase, because the person's body needs to be keep stably by one leg, an extra burden is imposed on the lower limb muscle. Thus, when the leg is narrowly moved forward, the swing phase is supposed to be short. Thus, it is considered that the walking stride is reflected in a time ratio of the swing phase relative to the time of one step, and it is set to an estimated indicator S4.

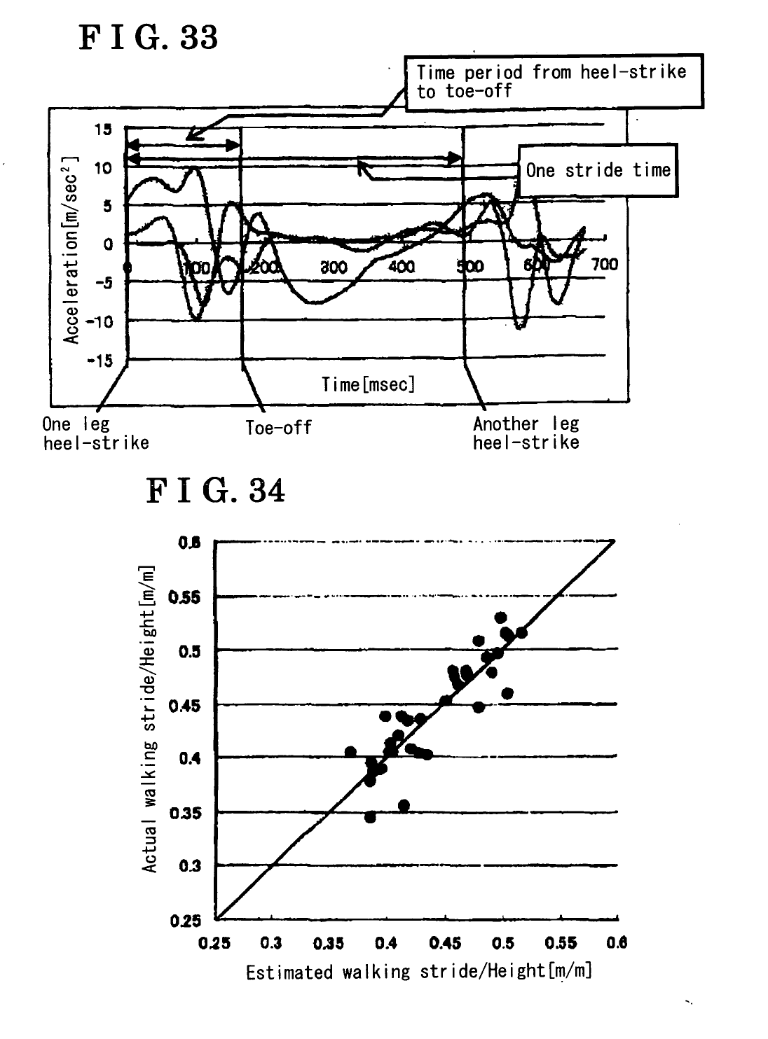

Estimated indicator S4=Time ratio of a period between the heel-strike to the toe-off relative to the time of one step. FIG. 33 illustrates an explanation diagram in the same manner as the graph in FIG. 7 indicating the heel-strike and the toe-off.
(Walking stride estimation formula=Relational formulas between the walking strides and the estimated indicators S)

When the walking speed is high, the walking stride tends to be wider. Thus, it is considered that a walking stride is calculated by use of a relational formula for estimating the walking stride using the estimated indicators S1 through S4 and the estimated indicators V1 through V7. A walking speed will be obtained by use of at least one of the estimated indicators S1 through S4 and the estimated indicators V1 through V7.

In this case, a relational formula is illustrated with a straight line in each of FIGS. 30 through FIG. 32. However, in order to increase the accuracy, the relational formula can be obtained by use of a multiple regression analysis with plural estimated indicators. An example of the estimated formula using the estimated indicators S1 through S4 will be explained.
Walking stride=0.163* estimated indicator S1−0.023* estimated indicator S2+0.286* estimated indicator S3+0.027* estimated indicator S4−0.236.

An estimated walking stride is calculated by substituting the estimated indicators calculated on the basis of the measured data into the above relational formula to see a correlation relation between an actual walking stride and the estimated walking stride. FIG. 34 illustrates a graph in which the x-axis indicates an estimated walking stride/body height (m/m), and the y-axis indicates actual walking stride/body height (m/m). The estimated walking stride/body height (m/m) and the actual walking stride/body height (m/m) are highly correlated. An example of the relational formula using the estimated indicators V4 through V7 Will be explained as follows.
Walking stride=0.11* estimated indicator V4+0.27* estimated indicator V6−0.06* estimated indicator V7+0.24.

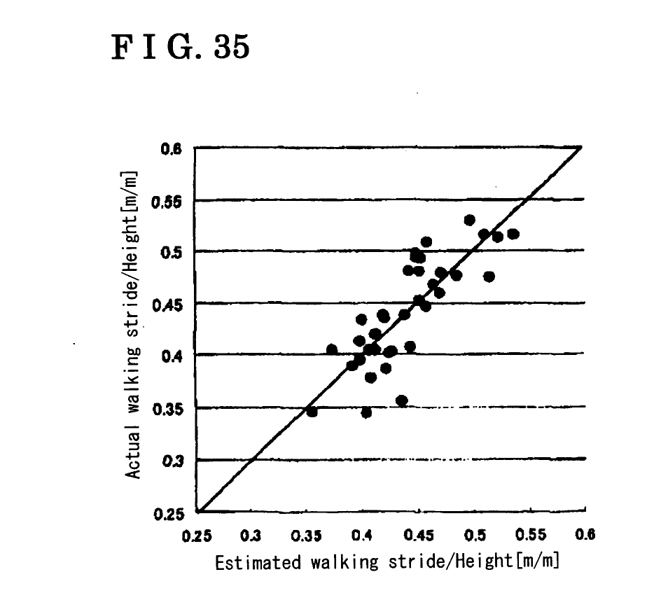

An estimated walking stride is calculated by substituting the estimated indicators calculated on the basis of the measured data into the above relational formula to see a correlation relation between the actual walking stride. FIG. 35 illustrates a graph in which the x-axis indicates an estimated walking stride/body height (m/m), and the y-axis indicates actual walking stride/body height (m/m).

The estimated walking stride/body height (m/m) and the actual walking stride/body height (m/m) are highly correlated.

As explained above, according to the embodiments of the present invention, a walking ability can be measured without a special technical knowledge by measuring an acceleration at the waist portion of the person.

Further, there is no burden for the test subjects. Furthermore, a certain time period in which a certain walking movement is performed is extracted, and on the basis of changes with time of the acceleration during the certain time period, an estimated indicator related to a walking speed or a walking stride is calculated. Thus, the walking speed or the stride is universally estimated.

According to the embodiments 1 through 4 of the present invention, when a certain time period while the person is walking is extracted, a certain time period at each of right and left legs is extracted, and an estimated indicator is calculated at each of the right and left legs. On the basis of the calculated estimated indicator, a walking ability of each of the right and left legs is estimated. A right certain time period in which the right walking movement is performed and a left certain time period in which the left walking movement is performed are determined on the basis of positive or negative changes with time of each acceleration. The positive acceleration or the negative acceleration is suitably set to either leg.

Thus, if this apparatus is used to give a rehabilitative training for a patient, because a walking speed and a walking stride is estimated on each leg, an effect of the training or a portion at which a training is needed is clearly defined, as a result, a treatment on the patient is operated effectively.

Further, according to the present invention, the walking ability is not limited to the above embodiments. Specifically, a space between the right leg and the left leg in a right-left direction, a range of movable angle of each joint (articulatio coxae, knee joint, ankle joint), a torque of each joint, a bending and extending muscle strength of each joint, floor reaction force and the like can be estimated as a walking ability. Further, a numerical value of a right-left balance of the walking ability and a numerical value of a distortion of lower limb bones can be estimated as a walking ability.

Furthermore, according to the present invention, the person may be notified of the estimated walking ability calculated by the methods explained in the above embodiments, at the same time, the person may also be notified of a guidance (training guidance) to improve his/her walking ability. For example, the walking ability is divided into stages, and a training guidance, which is considered to be appropriate foe each stage, is prepared in advance. On the basis of the estimated walking ability, a stage of the person's walking ability is determined, and an appropriate training guidance of that stage may be displayed on the display portion 40. The person may be notified of the training guidance by another means.

Hereinafter, how a risk of person's fall is determined is explained on the basis of the walking speed and the length of stride. A person's pace is calculated by the following formula.
Pace (step/min)=walking speed (m/sec)/length of stride (m)

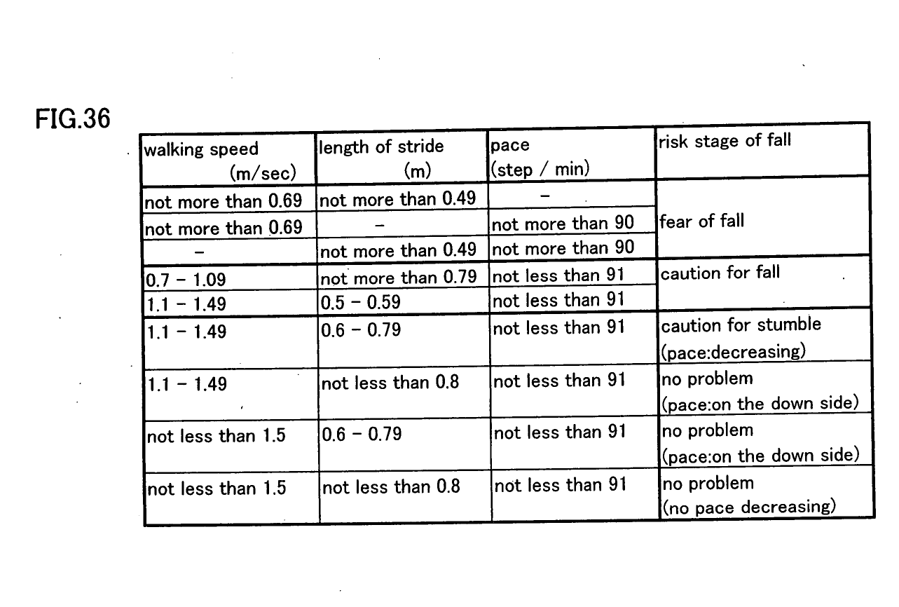

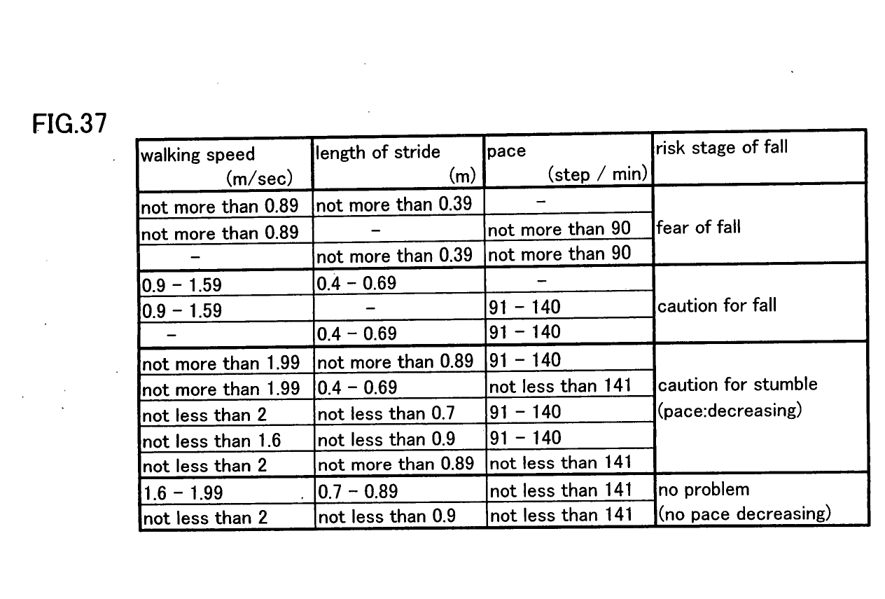

Combining the pace, the walking speed, and the length of stride all of which are in grade mode constitutes diagnostic tables as shown in FIGS. 36 and 37 when the walking speeds are normal and maximum, respectively. In these tables, the risk of fall is divided into five stages: “fear of fall”, “caution for fall”, “caution for stumble (pace: decreasing)”, “caution for stumble (pace: on the downside)”, and “no problem”. It is to be noted that the interval that constitutes the above grade is variable.

Depending of the risk stage of fall, the CPU 24 is capable of indicating a message on the display 40 to the person for recognizing his/her current condition of risk of fall.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A walking analyzer comprising:
an acceleration sensor detecting an up-down acceleration, a front-rear acceleration, and a right-left acceleration of a person, the up-down acceleration including an acceleration in an up-down direction at a waist portion while the person is walking, the front-rear acceleration including an acceleration in a front-rear direction at the waist portion while the person is walking, and the right-left acceleration including an acceleration in a right-left direction at the waist portion while the person is walking;
an acceleration change calculating means for calculating changes of each acceleration in time, the each acceleration being detected by the acceleration sensor;
a time period extracting means extracting a certain time period in which a certain walking movement is performed on the basis of the changes of the acceleration in time of one of the up-down acceleration, the front-rear acceleration and the right-left acceleration;
an estimated indicator calculating means calculating an estimated indicator related to a walking ability on the basis of the changes in the time during the certain time period of the one of the up-down acceleration, the front-rear acceleration and the right-left acceleration; and
a walking ability estimating means estimating a walking ability by use of the estimated indicator calculated by the estimated indicator calculating means and by use of a predetermined relation between an estimated indicator and a walking ability.

2. The walking analyzer according to claim 1, wherein, on the basis of the changes of the acceleration in time, the time period extracting means extracts two time points from points at the time period where the certain walking movement is performed and sets a time period between the two points to the certain time period.

3. The walking analyzer according to claim 2, wherein the two time points are selected from a point at which a heel-strike is performed, a point at which a foot-bottom landing-on is performed and a point at which a tow leaving movement is performed.

4. The walking analyzer according to claim 1, wherein the time period extracting means extracts the certain time period in which the certain walking movement is performed by each of the right and left legs, and the walking ability estimating means estimates the walking ability at each of the right and left legs.

5. The walking analyzer according to claim 1, wherein the walking ability is selected from a dorsiflexion force, a knee extension force, a walking speed and a walking stride.

6. The walking analyzer according to claim 1, wherein the acceleration sensor, the time period extracting means, the estimated indicator calculating means and the walking ability estimating means are integrated so as to be attached to and detached from the waist portion.

7. The walking analyzer according to claim 1, wherein the walking analyzer further includes a display means displaying the walking ability estimated at the walking ability estimating means.

8. The walking analyzer according to claim 1, wherein the walking ability is displayed at the display means as one of analog data and digital data.

9. The walking analyzer according to claim 8, wherein the walking analyzer further includes a memory means memorizing the walking ability estimated at the walking ability estimating means.

10. The walking analyzer according to claim 8, wherein the memory means is provided so as to be detached from the walking analyzer.

11. A walking analyzing method comprising:
an acceleration measuring step detecting an up-down acceleration, a front-rear acceleration, and a right-left acceleration of a person, the up-down acceleration including an acceleration in an up-down direction at a waist portion while the person is walking, the front-rear acceleration including an acceleration in a front-rear direction at the waist portion while the person is walking, and the right-left acceleration including an acceleration in a right-left direction at the waist portion while the person is walking;
a acceleration change calculating step for calculating changes of each acceleration in time, the each acceleration being detected by the acceleration sensor;
a time period extracting step extracting a certain time period in which a certain walking movement is performed while walking on the basis of the changes in the time of one of the up-down acceleration, the front-rear acceleration and the right-left acceleration;
an estimated indicator calculating step calculating an estimated indicator related to a walking speed or a walking stride while walking on the basis of the changes in the time during the certain time period of one of the up-down acceleration, the front-rear acceleration and the right-left acceleration; and
one of a walking speed estimating step and a walking stride estimating step, a walking speed estimating step estimating a walking speed by use of the estimated indicator calculated by the estimated indicator calculating step and by use of a predetermined relation between an estimated indicator and a walking speed, and a walking stride estimating step estimating a walking stride by use of the estimated indicator calculated by the estimated indicator calculating step and by use of a predetermined relation between an estimated indicator and a walking stride.

12. The walking analyzing method according to claim 11, wherein, on the basis of the changes of the acceleration in the time, the time period extracting step extracts two time points from the time period where the certain walking movement is performed and sets a time period between the two points to the certain time period.

13. The walking analyzing method according to claim 11, wherein the two time points are selected from a point at which a heel-strike is performed, a point at which a foot-bottom landing-on is performed and a point at which a tow leaving movement is performed.

14. The walking analyzing method according to claim 11, wherein the time period extracting step extracts the certain time period in which the certain walking movement is performed by each of the right and left legs, and the walking speed estimating step estimates the walking speed at each of the right and left legs.

15. The walking analyzing method according to claim 11, wherein the time period extracting step extracts the certain time period in which the certain walking movement is performed by each of the right and left legs, and the walking stride estimating step estimates the walking stride at each of the right and left legs.

16. The walking analyzing method according to claim 5, wherein each of the walking stride and the walking speed is selected to derive a pace, the pace being derived by dividing the walking speed by the length of stride, the resulting pace, the length of stride and the walking speed being combined to indicate risk stages of fall.

17. The walking analyzing method according to claim 16, wherein one of the risk stages of fall is displayed to provide a diagnostic depending on the person's walking ability.
